(19) United States
(12) Patent Application Publication
(10) Pub. No.: US 2002/0010661 A1
(43) Pub. Date: Jan. 24, 2002

(54) Distribution system

(76) Inventors: Steffanie G. Waddington, SouthLake, TX (US); Dan A. White, Collierville, TN (US); Thomas M. Magill, Walnut Creek, CA (US); Donald G. Walker, Castro Valley, CA (US); Erwin Milton Jesse Bork, III, Hercules, CA (US); Warren T. George, Alamo, CA (US)

Correspondence Address: Jon D. Shutter, Howrey Simon Arnold & White, LLP, P.O. Box 4433, Houston, TX, 77210, US

(21) Appl. No.: 09/867,814

(22) Filed: May 30, 2001

Related U.S. Application Data
(60) Provisional application No. 60/208,133, filed on May 31, 2000.

(51) Int. Cl. G06F 17/60

(52) U.S. Cl. 705/28

(57) ABSTRACT

A distribution system for transferring a plurality of items from a distribution center to a customer comprises a delivery device and a retail device. The delivery device identifies the items and maintains a delivery record of a transfer of the items from the distribution center to the customer. The retail device identifies the items and maintains a receipt record of the transfer of the items. Upon identifying the item, the delivery device displays a description of the item on a display screen, such as the display on a portable computer. The delivery device identifies the items with a barcode scanner. The delivery device also includes a data entry apparatus to enter transfer information, such as an electronically captured signature, into the delivery record.

The present application claims the benefit of co-pending U.S. Provisional Patent Application Ser. No. 60/208,133, which was filed on May 31, 2000.

### FIELD OF THE INVENTION

The field of the invention is a distribution system, and more particularly, a distribution system for transferring ordered items from one point to another, such as from a warehouse to a customer.

### BACKGROUND OF THE INVENTION

Retail stores, including pharmacies, drug stores or other non-retail entities, require the delivery of products on a routine basis. Typically, the retail stores rely on a distribution system to supply them with products. The general distribution system includes a distribution center and a fleet of delivery vehicles. The distribution center receives orders for specific items, and the delivery vehicles transport those products to the retail store.

The distribution center generally comprises a warehouse storing a large volume of various items. The retail stores order specified quantities of the products from the distribution center. To coordinate the transfer of the ordered items, an invoice generated by the distribution center lists the quantities of items ordered by retail store. Typically, warehouse personnel gather the listed quantities of items on the invoice from their storage locations in the warehouse. The warehouse personnel then place the ordered items into shipping units for shipment to the retail store. Each shipping unit has a unique label representing the invoice and retail store. The filled shipping units are then moved to the shipping dock area of the warehouse.

Delivery vehicles transfer the shipping units with the ordered items from the warehouse docks to the retail stores. Each delivery vehicle has a specific delivery route stopping at several retail stores along their route. At the warehouse dock or any cross-docks, the delivery vehicle receives the shipping units for delivery on their scheduled route. A driver of the vehicle receives a manifest for each retail store identifying the shipping units to be delivered at that stop.

At the retail store, the driver unloads shipping units from the delivery vehicle corresponding to the manifest. The driver checks the manifest for each shipping unit delivered. A receiving agent or clerk of the retail store receives the shipping units from the driver and verifies their contents. After all of the shipping units have been transferred to the retail store, the clerk signs the manifest and receives an invoice. The driver then continues to the next retail store on the designated route. After all deliveries have been made, the driver returns to the distribution center to provide copies of the signed manifests verifying the deliveries. The distribution center maintains the manifests for tracking and billing purposes.

The conventional distribution system has several shortcomings. One shortcoming is the volume of paper involved in the above deliveries. Typically, several copies of the manifest and invoice must be maintained in files. One problem with so many papers is the tendency for the paper copies to be lost or damaged. Another problem with maintaining paper records is the time and labor costs. An additional shortcoming of the conventional distribution system is driver error. The driver may deliver the wrong shipping unit to a retail store. This driver error requires that the shipping units be returned to the distribution center for redirection to the proper retail store. Additionally, this driver error adversely affects the retail store if the items were needed immediately. A further shortcoming of the conventional distribution system is the difficulty the receiving retail store has verifying the deliveries. For a delivery comprising a large volume of shipping units, the clerk must either trust the driver is delivering the proper shipping units or perform a time consuming check of the shipping units and their contents.

In the convention distribution system, the retail stores order products from the distribution center using a catalog supplied by the distribution center. The ordering agent or clerk of the retail store must generate the order using item identification numbers provided in the catalog. Typically, the clerk writes down the identification number and a quantity of the desired item. After compiling the identification numbers and quantities of the items to order, the clerk then transmits the order by mail or facsimile to the distribution system. One shortcoming of the ordering process is the volume of paper involved in the above transactions. Another problem is the time and labor costs to generate the order. An additional shortcoming of the conventional ordering process is employee error. The clerk may enter the wrong identification numbers or quantity for the item. This error requires that the shipping units be returned to the distribution center. Additionally, this error adversely affects the retail store if the items were needed immediately.

Thus, there is a need for a distribution system that reduces the amount of paper, reduces the possibility of error, reduces the review of the delivery by the receiving agents, and simplify the ordering process.

### SUMMARY OF THE INVENTION

According to one aspect of the present invention, there is provided a distribution system for transferring a plurality of items from a distribution center to a customer. The distribution system comprises a delivery device and a retail device. The delivery device identifies the items and maintains a delivery record of a transfer of the items from the distribution center to the customer. The retail device identifies the items and maintains a receipt record of the transfer of the items. Upon identifying the item, the delivery device displays a description of the item on a display screen, such as the display on a portable computer. The delivery device identifies the items with a barcode scanner. The delivery device also includes a data entry apparatus to enter transfer information, such as an electronically captured signature, into the delivery record. The delivery device also stores a driver manifest record. The driver manifest record contains a description of the customer, a listing of the items to delivery and a status of the items, such as delivered or not delivered. The driver manifest record may further contain a listing of a second customer and a second plurality of items to be transferred to the second customer. The retail device is also capable of creating an ordering record of a plurality of items by identifying the item and a quantity of the item to order from the distribution center. The retail device is further capable of creating an inventory record by identifying the items and their quantity within a store. Moreover, the retail device is capable of creating a price change record by identifying the item and changing a price associated with the item. Furthermore, the retail device is capable of creating a returns record by identifying a return item to return to the distribution center. The distribution system also includes a distribution center computer capable of communicating with the delivery device and retail device to transfer the above-described records.

According to another aspect of the present invention, there is provided a method for distributing a plurality of items to a customer. The method comprises placing the items destined for the customer into a shipping unit and placing a label on the shipping unit. The label has a unique identifier used to identify the container and its contents. The method further comprises creating a shipment record identifying the shipping unit by its identifier and listing the items within the shipping unit. The method sends the shipping record to the customer and delivers the shipping unit to the customer. The customer receives the shipping unit and identifies the shipping unit by electronically reading the identifier on the label. The customer verifies the contents of the shipping unit using the listing of the items within the container in the shipping record. The customer electronically records any discrepancy between the contents of the shipping unit and the listing in the shipping record. The method further includes creating a delivery record of the delivery by electronically reading the identifier as the shipping unit is delivered. A receipt record of the receipt of the shipping unit may also be created by identifying the shipping unit and recording any differences between the items listed on the shipping record and the items within the container. A signature confirming delivery of the shipping unit to the customer may be electronically captured, and the time of delivery may be electronically recorded.

### BRIEF DESCRIPTION OF THE DRAWINGS

Other aspects and advantages of the invention will become apparent upon reading the following detailed description and upon reference to the drawings.

FIG. 1 is an overview block diagram of a distribution system;

FIG. 2 is a flow chart of the operations performed by a distribution center for one embodiment of the present invention;

FIG. 3 is a container label for one embodiment of the present invention;

FIG. 4 is a perspective of a delivery device for one embodiment of the present invention;

FIG. 5 is a flow chart of the operations performed by a driver of a delivery vehicle for one embodiment of the present invention;

FIG. 6 is a perspective of an upload and download system for one embodiment of the present invention;

FIG. 7 is a screen capture of a route selection screen for one embodiment of the present invention;

FIG. 8 is a screen capture of the route selection screen for one embodiment of the present invention;

FIG. 9 is a screen capture of a preload screen for one embodiment of the present invention;

FIG. 10 is a screen capture of the preload screen for one embodiment of the present invention;

FIG. 11 is a screen capture of the preload screen for one embodiment of the present invention;

FIG. 12 is a screen capture of a nonload screen for one embodiment of the present invention;

FIG. 13 is a screen capture of a driver manifest screen for one embodiment of the present invention;

FIG. 14 is a screen capture of the driver manifest screen for one embodiment of the present invention;

FIG. 15 is a screen capture of a stop information screen for one embodiment of the present invention;

FIG. 16 is a screen capture of the driver manifest screen for one embodiment of the present invention;

FIG. 17 is a screen capture of the driver manifest screen for one embodiment of the present invention;

FIG. 18 is a screen capture of a signature collection screen for one embodiment of the present invention;

FIG. 19 is a screen capture of the signature collection screen for one embodiment of the present invention;

FIG. 20 is a screen capture of the signature collection screen for one embodiment of the present invention;

FIG. 21 is a screen capture of a nondelivery manifest screen for one embodiment of the present invention;

FIG. 22 is a screen capture of a pickup screen for one embodiment of the present invention;

FIG. 23 is a screen capture of a query page for delivery information for one embodiment of the present invention;

FIG. 24 is a screen capture of a search results page for delivery information for one embodiment of the present invention;

FIG. 25 is a perspective of a retail device for one embodiment of the present invention;

FIG. 26 is a flow chart of the operations performed by a receiving agent of a delivery for one embodiment of the present invention;

FIG. 27 is a flow chart of the operations performed by an ordering agent for creating an order of items for one embodiment of the present invention;

FIG. 28 is a block diagram of an upload and download system for one embodiment of the present invention;

FIG. 29 is a screen capture of a receiving screen for one embodiment of the present invention;

FIG. 30 is a screen capture of the receiving screen for one embodiment of the present invention;

FIG. 31 is a screen capture of the receiving screen for one embodiment of the present invention;

FIG. 32 is a screen capture of the receiving screen for one embodiment of the present invention;

FIG. 33 is a screen capture of a find screen for one embodiment of the present invention;

FIG. 34 is a screen capture of the find screen for one embodiment of the present invention;

FIG. 35 is a screen capture of the find screen for one embodiment of the present invention;

FIG. 36 is a screen capture of an order creation screen for one embodiment of the present invention;

FIG. 37 is a screen capture of an ordering screen for one embodiment of the present invention;

FIG. 38 is a screen capture of the ordering screen for one embodiment of the present invention;

FIG. 39 is a screen capture of the ordering screen for one embodiment of the present invention;

FIG. 40 is a screen capture of the ordering screen for one embodiment of the present invention;

FIG. 41 is a screen capture of a find screen for one embodiment of the present invention;

FIG. 42 is a screen capture of the find screen for one embodiment of the present invention; and

FIG. 43 is a screen capture of an item detail screen for one embodiment of the present invention;

FIG. 44 is a flow chart of the inventory procedures performed by a clerk for one embodiment of the present invention;

FIG. 45 is a screen capture of an inventory main screen for one embodiment of the present invention;

FIG. 46 is a screen capture of an inventory header screen for one embodiment of the present invention;

FIG. 47 is a screen capture of an inventory entry screen for one embodiment of the present invention;

FIG. 48 is a screen capture of an item detail screen for one embodiment of the present invention;

FIG. 49 is a flow chart of the returns procedures performed by a clerk for one embodiment of the present invention;

FIG. 50 is a screen capture of a returns main screen for one embodiment of the present invention;

FIG. 51 is a screen capture of a returns header screen for one embodiment of the present invention;

FIG. 52 is a screen capture of a returns entry screen for one embodiment of the present invention;

FIG. 53 is a screen capture of the returns entry screen for one embodiment of the present invention;

FIG. 54 is a flow chart of the retail price change procedures performed by a clerk for one embodiment of the present invention;

FIG. 55 is a screen capture of a retail main screen for one embodiment of the present invention;

FIG. 56 is a screen capture of a retail header screen for one embodiment of the present invention;

FIG. 57 is a screen capture of a retail entry screen for one embodiment of the present invention;

FIG. 58a and 58b are screen captures of an item detail screen for one embodiment of the present invention;

FIG. 59 is a screen capture of a retail entry screen for one embodiment of the present invention;

FIG. 60 is a flow chart of the sticker request procedures performed by a clerk for one embodiment of the present invention;

FIG. 61 is a screen capture of a sticker main screen for one embodiment of the present invention;

FIG. 62 is a screen capture of a sticker header screen for one embodiment of the present invention; and

FIG. 63 is a screen capture of a sticker entry screen for one embodiment of the present invention.

While the invention is susceptible to various modifications and alternative forms, specific embodiments thereof have been shown by way of example in the drawings and are herein described in detail. It should be understood, however, that the description herein of the specific embodiments is not intended to limit the invention to the particular forms disclosed, but on the contrary, the intention is to cover all modifications, equivalents, and alternatives falling within the spirit and scope of the invention as defined in the appended claims.

### DESCRIPTION OF ILLUSTRATIVE EMBODIMENTS

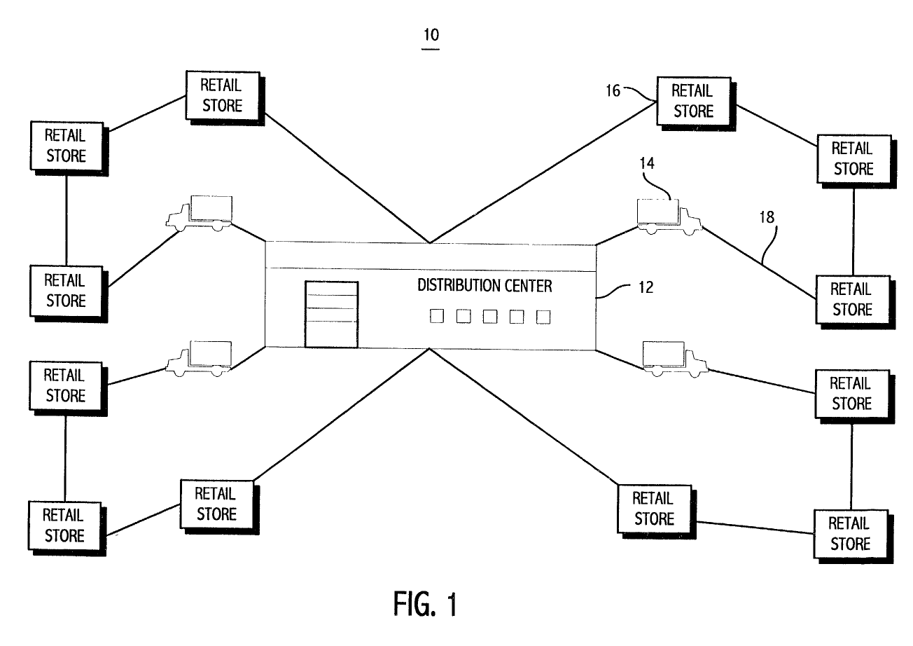

Turning now to the drawings and referring initially to FIG. 1, there is depicted an overview of a distribution system 10 according to the present invention. The distribution system 10 comprises a distribution center 12 and a fleet of delivery vehicles 14. In the general operation of the distribution system 10, a retail store 16 places an order for items with the distribution center 12. After receiving the order, the distribution center 12 gathers the ordered items from its warehouse and places them into shipping units. Typically, the shipping unit is a stackable, reusable container called a tote. Generally, the container has a cover that houses and protects the items placed within the container. Alternatively, the items may also gathered onto pallets, bags, coolers or may be shipped in the manufacturer's packaging. The filled containers are then moved to a shipping dock area of the distribution center 12. Delivery vehicles 14 receive the containers with the ordered items from the warehouse docks. Each delivery vehicle has a specific delivery route 18 stopping at several retail stores 16 along the route 18. At the retail store 16, the containers carrying items, ordered by that retail store 16, are unloaded from the delivery vehicle 14. The delivery vehicle 14 then continues to the next retail store 16 on the designated route 18. After completing all of the deliveries, the delivery vehicle 14 returns to the distribution center 12.

In other embodiments of the distribution system 10, the delivery vehicles make deliveries directly to customers or other entities. For example, the distribution system 10 may supply items to hospitals, universities, businesses, residences or any type of entity. In other embodiments, the large delivery vehicles may transfer their items or shipping containers to several smaller delivery vehicles which in turn may transfer their items or shipping containers to other even smaller delivery vehicles before eventual delivery to the retail store or other non-retail entity. In further embodiments, the retail store or non-retail entity does not need to place an order with the distribution center to receive deliveries. Moreover, the delivery vehicles may deliver any type of items or shipping units with many items.

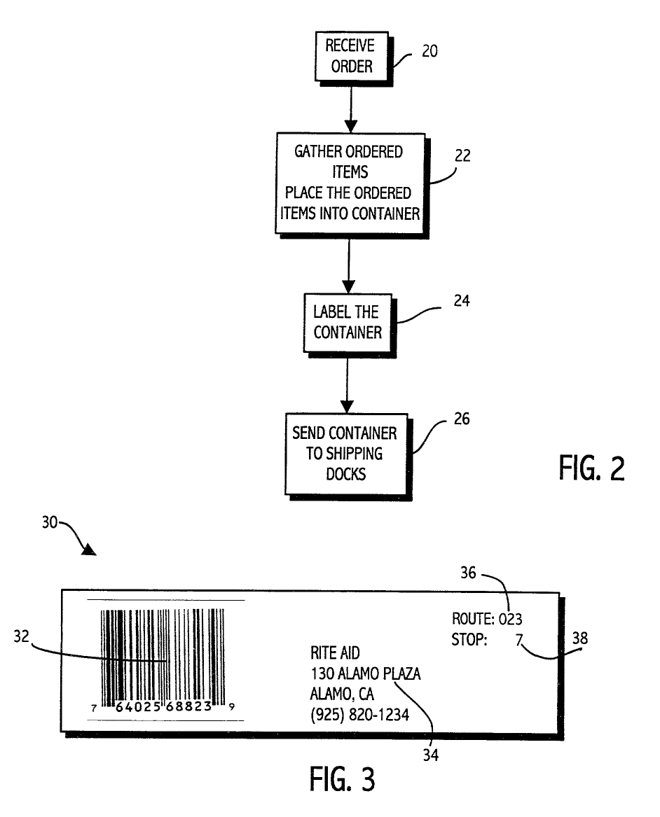

The distribution center 12 generally performs the steps illustrated in FIG. 2 to service orders from the retail stores 16 or other entity. First, the distribution center 12 receives the order at step 20. In one embodiment, a centralized computer system or distribution center computer system receives the order through a communication link, such as the Internet, with the retail store 16 or customer. In other embodiments, the order may be received by mail, facsimile or telephone. All orders are entered into the distribution center computer system. The distribution center computer system runs a software package designed to manage the operations of the distribution center 12. The software package provides inventory management including item storage locations and quantity of the items in the warehouse. The software package also coordinates servicing of the orders. One example of the distribution center software package is ACUMAX™ developed and used by MckessonHBOC, the assignee of the present invention. In an alternative embodiment, a centralized computer system, such as a host server located away from the distribution center warehouse, performs the operations of the distribution center computer system. One centralized computer system may perform the distribution operations for several distribution centers. Additionally, the distribution center computer system may be a stand-alone computer, located within or away from the distribution center.

After the order has been received, warehouse staff gather the ordered items into containers destined for the retail store at step 22. In one embodiment, the warehouse staff obtain a copy of the order on a wrist-mounted computer or other computer workstation in communication with the distribution center computer system. The wrist-mounted computer may communicate with the distribution center computer system over a wireless link. The warehouse staff utilizes a scanner attached to the wrist computer or workstation to scan an identifying barcode of an empty container. The scanned container will hold ordered items for shipping to the retail store. Each shipping container has an identifying barcode to distinguish it from similar appearing containers.

To assist the staff with filling the container, the wrist-mounted computer then instructs the staff to go to a certain location in the warehouse and scan the barcode associated with that location. If the correct location barcode has been scanned, the wrist-mounted computer describes the item stored at that location and quantity of the item required by the order on its display. The staff picks the items from the shelves and enters in a quantity of that item placed into the container. Typically, the staff uses the scanner on the wrist-mounted computer to read the barcode of items as they are placed into the container.

Once all of the ordered items have been placed into the container, the warehouse personnel print a label that is adhered to the container at step 24. If all of the ordered items do not fit into a single container, additional containers are filled with ordered items following a similar procedure as described above. The labeled containers are sent to the shipping dock at step 26. In one embodiment, after the containers are labeled, the staff scans a location barcode corresponding to the position within the warehouse of the labeled containers before completing the process. This allows a different staff person to collect the various containers from different warehouse locations and take them to the designated shipping dock.

FIG. 3 illustrates a container label 30 according to one embodiment of the present invention. The label 30 has a unique identifier 32 used to identify the container and its contents. In the embodiment, the identifier is a barcode 32. Additionally, the label 30 includes a retail store name and address information 34, a route number 36 and a stop number 38. The route number 36 corresponds to a specific route 18 assigned to a specific delivery vehicle 14. The route number 36 determines onto which delivery vehicle 14 the containers are loaded. The stop number corresponds to one of the retail stores 16 or other entities on the specified route 18 of the delivery vehicle. Other information may be included on the label including an account number and department number further identifying the retail store 16. Additionally, the label 30 may indicate whether the contents of the container are hazardous, the type of items shipped in the container such as over-the-counter, prescription or narcotic. Moreover, the label may indicate how many other shipping units are destined to this retail store 16.

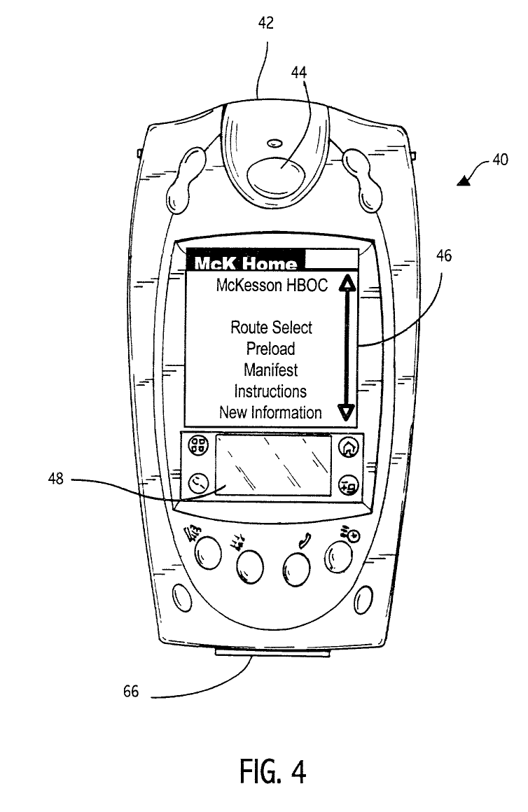

To coordinate the transfer of the containers from the shipping docks of the distribution center 12 to the retail stores 16 or customers, the driver of the delivery vehicle 14 has a delivery device 40 as illustrated in FIG. 4. In one embodiment, the delivery device 40 is a Palm Computing platform incorporated in a rugged housing sold by Symbol Technologies. The delivery device includes a scanning device that reads the identifier 32 on the label 30. In one embodiment, the delivery device 40 includes a laser barcode scanner 42 activated by a scanner button 44. The delivery device also includes a display screen 46 and a graffiti area 48. The delivery device 40 includes a stylus (not shown) as used with the Palm Computing platform. The driver may select information from the delivery device 40 by tapping on the display screen 46 with the stylus. The delivery device 40 is programmed with delivery software to assist the driver with the delivery of the containers to the customers and to collect information regarding the deliveries. In other embodiments, the delivery device 40 may comprise a portable computer such as a notebook computer with a scanner attachment.

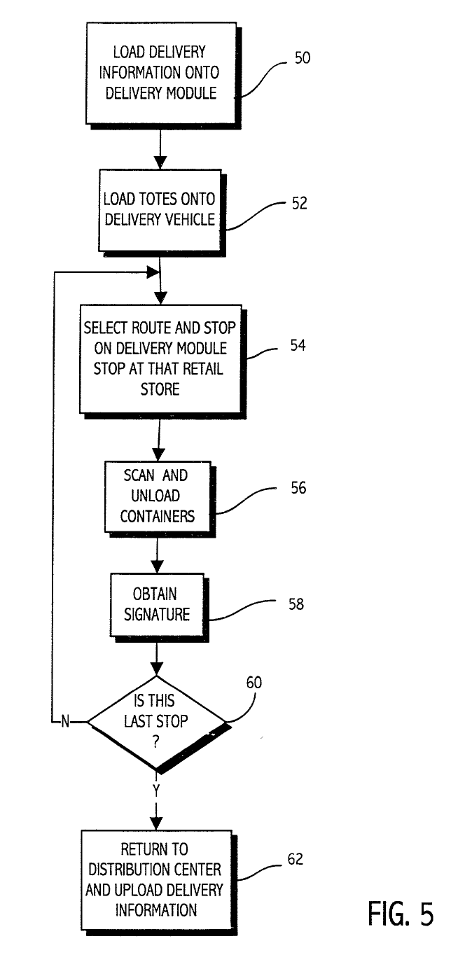

FIG. 5 illustrates the general operations performed for the delivery of the containers. A more detailed description of the delivery operations will be described below. First, the delivery device 40 downloads a delivery information file from the distribution center computer system at step 50. The labeled containers or other labeled shipping units containing ordered items, such as cases, bags, coolers and pallets, are loaded onto the delivery vehicle 14 according to the route number 36 on their labels 30 at step 52. Using the delivery device 40, the driver selects a route and stop on the delivery device 40 and stops at the corresponding retail store 16 or customer at step 54. At the retail store 16, the driver scans the barcodes 32 of the labeled containers corresponding to the retail store 16 and unloads those containers at the retail store 16 at step 56. Once all of the containers destined for the retail store 16 are unloaded, the driver obtains a signature with the delivery device 40 of the receiving agent or clerk at the retail store 16 to confirm the delivery of the containers at step 58. After the delivery has been completed at that retail store 16, the driver determines whether that retail store 16 is the last stop at step 60. If additional deliveries must be made at other retail stores 16, the driver returns to step 54 and selects the next stop. If the answer at step 60 is yes, the driver returns to the distribution center 12 at step 62. Upon return to the distribution center 12, the delivery information captured on the delivery device 40 during the deliveries is uploaded to the distribution center computer system.

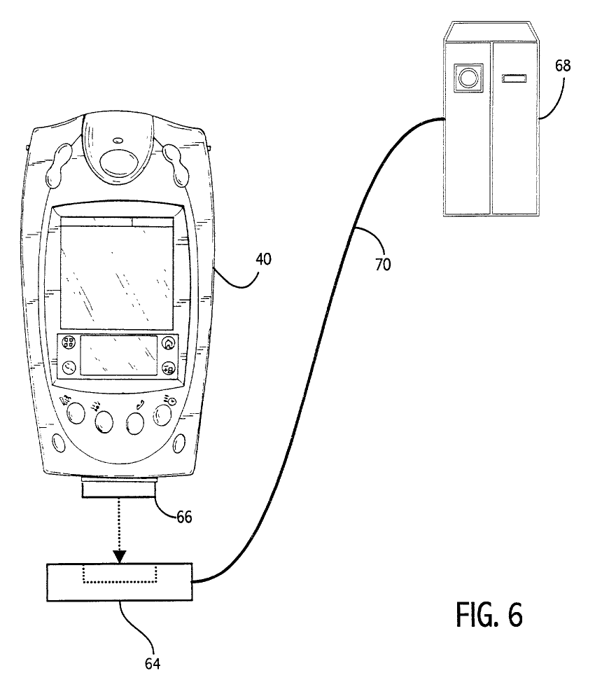

FIG. 6 depicts one embodiment for downloading and uploading the delivery information to and from the delivery device 40 of steps 50 and 62 in FIG. 5. The delivery device 40 connects with a cradle 64 through contacts 66 (see FIG. 4). The distribution center computer system 68 connects to the cradle 64 via cable 70. The delivery information file is communicated between the distribution center computer system 68 and the delivery device 40 through the cable 70. In an alternative embodiment, the delivery device 40 wirelessly communicates with the distribution center system computer 68. With the wireless communications, the delivery information file may be downloaded and uploaded all at once in real time or the distribution center computer system 68 and the delivery device 40 may frequently exchange delivery information. In an alternative embodiment, the delivery information file is communicated to a stand-alone computer with the cradle 64 and cable 70. The delivery information file includes driver manifest information used to make the deliveries. The manifest information includes information on the containers that will be loaded onto the delivery vehicle 14. The manifest information also includes route and stop information.

After downloading the delivery information of step 50, the delivery vehicle 14 is loaded with containers according to the route numbers 36 on the labels 30 at step 52. In an alternative embodiment, as the labeled containers are placed into the delivery vehicle 14, the driver uses the delivery device 40 to scan the barcodes 32 on the labels 30 of the containers. In this embodiment, the delivery device 40 obtains data to verify that the containers required for the deliveries are placed onto the delivery vehicle 14 as described below with the preload option on the delivery device 40.

The delivery device 40 assists the driver with the deliveries. FIG. 4 illustrates the delivery device 40 having a home screen on the display screen 46. The illustrated embodiment depicts the driver device 40 programmed for drivers of McKessonHBOC, assignee of the present application. In other embodiments, the delivery device may be programmed for drivers of other delivery or supply services. The home screen provides the driver with the options of “Route Select,” “Preload,” “Manifest,” “Instructions,” and “New Information.” The driver selects one of the options by tapping the icon or the field corresponding the location of the text of the option on the display screen 46. Selection of the “Instructions” option provides a list of topics that explain the features of the delivery device 40. By selecting one of the listed topics, the display screen 46 provides a detailed description of the procedures for the selected topic. Selection of the “New Information” option provides a listing of news alerts from the distribution center 12.

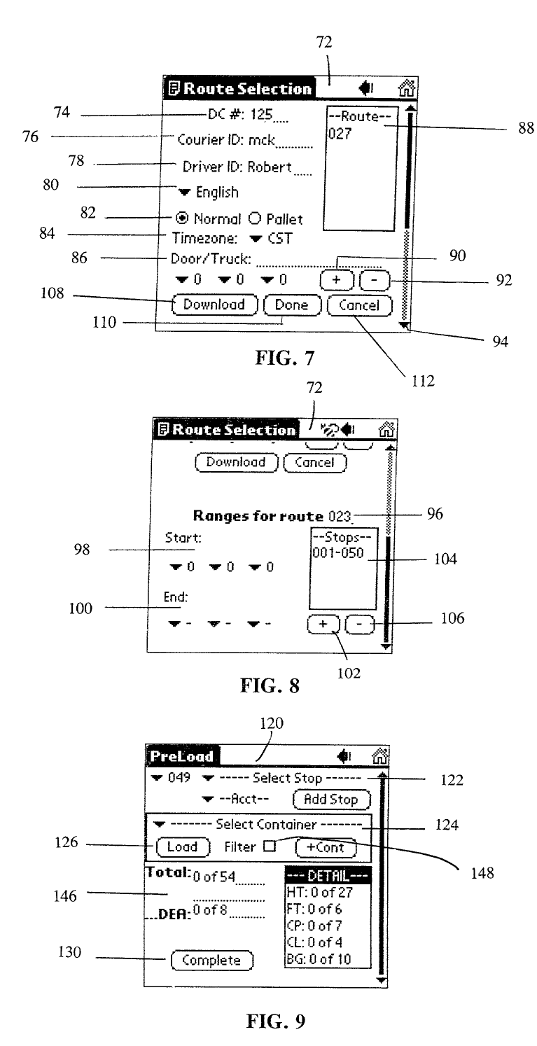

If the driver selects the “Route Select” option, the display screen 46 provides a route selection screen 72 as illustrated in FIG. 7. The driver prepares the delivery device 40 for the delivery procedures. The route selection screen 72 lists the distribution center identification number “DC #:” 74, courier identification code “Courier ID:” 76, driver identification “Driver ID:” 78, and Door/Truck number “Door/Truck:” 86. The driver checks the validity of listed identifications. If the identifications are incorrect, the driver selects the appropriate field and enters the correct information. The route selection screen 40 provides a language preference drop list 80, such as English or Spanish that the driver changes using the drop list. Additionally, the route selection screen 72 provides a button group 82 used to choose between a normal mode of delivery where a delivery unit is a single container and a pallet mode where a delivery unit is an entire pallet of containers. The driver selects the appropriate mode by tapping the desired button.

Additionally, the route selection screen 72 lists the time zone with a “Timezone:” list box 84 of the delivery area. Because the delivery device 40 maintains a record of date and time of deliveries, the driver may change the time zone 82 of the delivery area to ensure correct time with the drop box that lists the various time zones. The route selection screen 72 also displays a “Route” list box 88 containing the currently selected routes. Routes may be added by selecting the route number, such as “027” as illustrated in FIG. 7, hitting a “+” button 90 and entering the appropriate new route number. Routes may be removed from the driver device 40 by selecting the route number, such as “027” as illustrated in FIG. 7, hitting a “−” button 92.

Because each route may consist of multiple stops, the range of stops for a selected route at which the driver will service may also be selected on the driver device 40. FIG. 8 illustrates the second page of the route selection screen 72 accessible via the page down arrow 94. Each route number has a range of stop numbers. If no stop range is set, all of the stops for the selected route will be selected by default. To select a specific range of stops for a route, the driver first selects the route number at a “Route” list box 88. After selecting the route, the driver then selects the beginning and ending numbers with the three single digit drop lists under “Start” 98 and “End” 100. The driver may add stops to a selected route with a “+” button 102 to increment the listed stops in a “Stops” box 104, such as “001-050” to “001-051.” To remove a stop from a selected route, the driver selects a “−” button 106 to decrement the listed stops in the stop box 104, such as “001-050” to “001-049.”

Once all of the setting on the route selection screen 72 have been entered or verified, the driver selects a “Done” button 110 to save the settings and return to the home screen. By selecting a “Download” button 108, a download flag is set within the driver device 40. The download flag signals that a new delivery information file is to be downloaded into the delivery device 40 the next time the delivery device 40 is synched with the distribution center computer system 68 as described in conjunction with FIG. 6. The driver selects a “Done” button 110 to save the entered settings and to exit the route selection screen 72 without setting the download flag. The driver selects a “Cancel” button 112 to return to the home page screen without out saving the entered settings.

If the driver selects the “PreLoad” option on the home screen, the display screen 46 provides a preload screen 120 to implement a preload process as illustrated in FIG. 9. The preload screen allows a driver to efficiently confirm that all of the containers on the manifest received by downloading the delivery information are present prior to loading them into the delivery vehicle. The preload screen also allows the driver to ensure that there are no extra shipping containers placed on the delivery vehicle. In one embodiment, the preload screen 120 cannot be entered once the deliveries have begun. Additionally, once preload process has begun, the deliveries cannot be started until preload process has been completed. The driver device 40 provides error messages on the display screen 46 to notify the driver of either of these events.

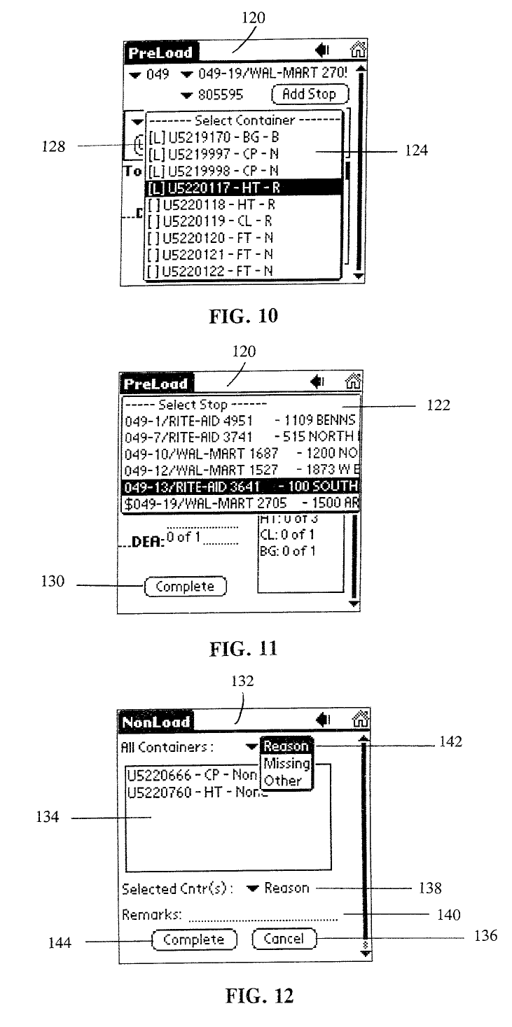

Generally, the driver selects the preload feature after the delivery information file including the manifest has been downloaded onto to the delivery device 40 from the distribution center computer system 68. After downloading the delivery information, the delivery 40 device contains records listing all of the containers and the items within the containers for the selected route(s) and stops. After entering the preload screen 120, the driver selects the last stop of displayed route from a “Select Stop” drop box 122. FIG. 10 illustrates the last stop of “049-18/WAL-MART 270!” for route “049” and its primary account number as “805595.” After selecting the last stop, the driver scans the label barcode 32 on the container or selects the corresponding container listed in a “Select Container” drop box 124 and press a “Load” button 126 for each container that belongs to the selected stop. As the containers are scanned an “L” is automatically placed in the brackets next to the container in the container drop box 124. If the driver wishes to change the status of the container, the driver may scan its barcode or select it manually and press an “Unload” button 128 that replaces the “Load” button 126 if the container was already flagged as loaded. Once all of the containers for each stop have been scanned (selected) and loaded, a “$” is displayed next to the stop information as illustrated in FIG. 11.

Once all of the containers have been loaded for all of the stops, the driver taps a “Complete” button 130. If all of the containers listed on the manifest for the stops have been correctly loaded, the driver device 40 displays the home screen. However, if some containers were not loaded, driver device 40 displays a nonload screen 132 as illustrated in FIG. 12. The nonload screen 132 provides a listing of the nonloaded containers 134 as illustrated in FIG. 12. If the driver has not purposely nonloaded the listed containers, the driver uses a “Cancel” button 136 to return to the preload screen 120 and to load those containers. Otherwise, the driver selects each of the nonloaded containers and enters a reason for not loading the container. A “Reason” drop box 138 provides the options of “Missing” or “Other.” If the driver selects the “Missing” option, the container will have a “?” in the bracket on the “Select Container” drop box 124. If the driver selects the “Other” option, the brackets will contain an “O.” When the driver selects the reason as “Other,” the driver enters comments about the container at a “Remarks” line 140. To quickly mark the status of all the containers with the same reason, the nonload screen 132 provides an “All Containers: Reason” drop box 142. In addition, the stops having nonloaded containers will be marked with an “*” on the “Select Stop” drop box 122. These statuses will be provided on the driver manifest screen described below, and they may be changed if the driver finds the missing container at the point of delivery. After all of the nonloaded containers have been accounted for, the driver taps a “Complete” button 144 to return to the preload screen 120.

The preload screen 120 on the delivery device 40 also provides summary information about the selected route and/or stop as shown in FIG. 9. A summary information field 146 lists the total number of preloaded and scheduled containers next to “Total,” the preloaded and scheduled narcotics next to “DEA” (the narcotics are included in the total for the Total), and a summary breakdown of the preloaded and scheduled containers titled “Detail.” The “Detail” identifies the container types such as half tote and full tote. The preload screen 120 also includes a “Filter” checkbox 148. The driver may tap this checkbox 148 to display in the “Select Container” list box 124 only those containers that have not been loaded. This feature helps the driver identify whether containers are missing. Additionally, if the driver discovers a container that is not in the “Select Container” drop box 124, the driver taps the “+Cont” button to enter the barcode number of the container's label. After completing the preload process, the driver is insured that all of the containers schedule for his delivery are either loaded on the delivery vehicle or accounted for as nonloaded.

In an alternative embodiment, the delivery vehicle 14 may be loaded with shipping containers from a cross-dock. That is, a large delivery vehicle unloads its shipping containers into several smaller delivery vehicles. The preload features on the delivery device 40, as described above on the delivery device 40, may also be used when loading the delivery vehicle from a cross-dock.

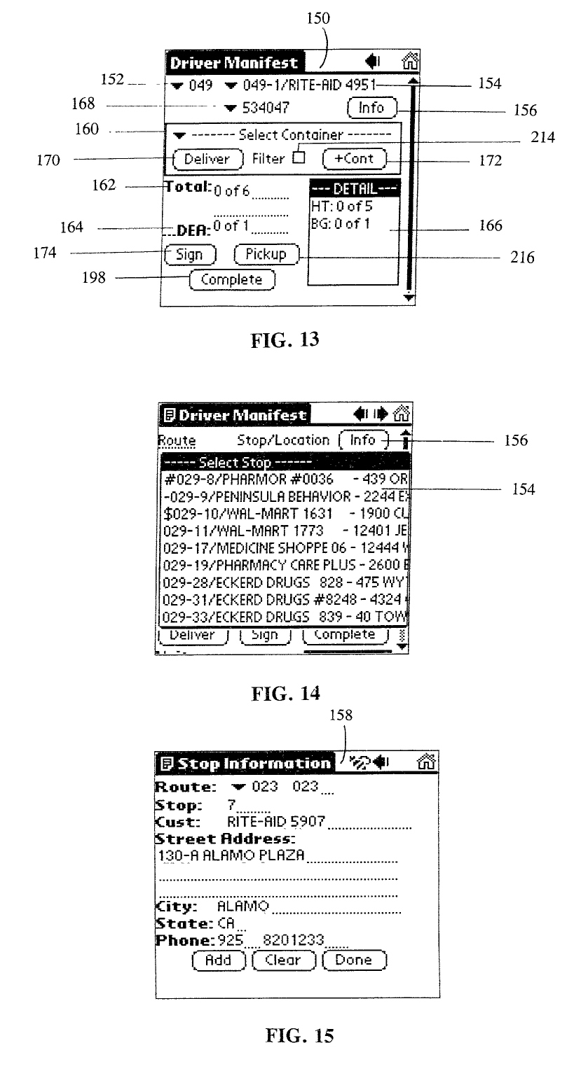

After the delivery vehicle 14 has been loaded with the containers, the driver departs the dock. To begin the deliveries, the driver selects the “Manifest” option on the home screen to view a manifest screen. The driver will use the manifest screen of the delivery device 40 to make the schedule deliveries. First the driver selects the route and stop to service of step 54 in FIG. 5. In one embodiment, the manifest screen initially requests the driver to acknowledge whether the date and time displayed are correct. If the date or time is incorrect, the delivery device 40 prompts the driver to enter the correct values. After the date and time are correct, the driver views a driver manifest screen 150 as illustrated in FIG. 13 to select the route and stop. On the driver manifest screen 150, the driver selects the route number by using a route list box 152 and highlighting the desired route such as “049.” The driver then selects a stop from the “Select Stop” list box 154.

After the route and stop have been selected, an account number corresponding to stop is displayed. As illustrated in FIG. 14, the Stop/Location list box 154 displays each stop for the selected route “029.” For each stop, the list box 154 provides the route/stop number, the customer's name and as much of the address that can be displayed. The list box 154 also provides a status flag for each stop with “ ” representing that the stop does not have any delivered containers, “*” representing that the stop has at least one signature but is not complete, “$” representing that the stop is complete with all containers signed for, “#” representing that the stop is complete but has containers flagged as “Missing” or “Refused,” and “-” representing that the stop is complete but has containers flagged as “Closed.” For example, the displayed “$029-10/WAL-MART 1631-1900” represents that stop number “10” on route “029” is the Wal-Mart store with street number 1900, and all containers destined for that stop have been delivered and a signature has been captured.

If the driver needs more information about a stop, the driver taps an “Info” button 156 (see FIG. 13) on the manifest screen 150. Tapping the “Info” button 156 provides a stop information screen 158 as illustrated in FIG. 15. The stop information screen 158 provides additional stop details including the complete address and telephone information for the retail store 16. On the stop information screen 158, the driver may change the listed information and then taps an “Add” button to have the changes saved. To return to the driver manifest screen 150 and have the changes save, the driver taps a “Done” button; otherwise, the driver taps a “Clear” button to discard the changes. If the driver selects the “Info” button 156 when no stop is highlighted, the driver uses the “Add” button to enter a new stop.

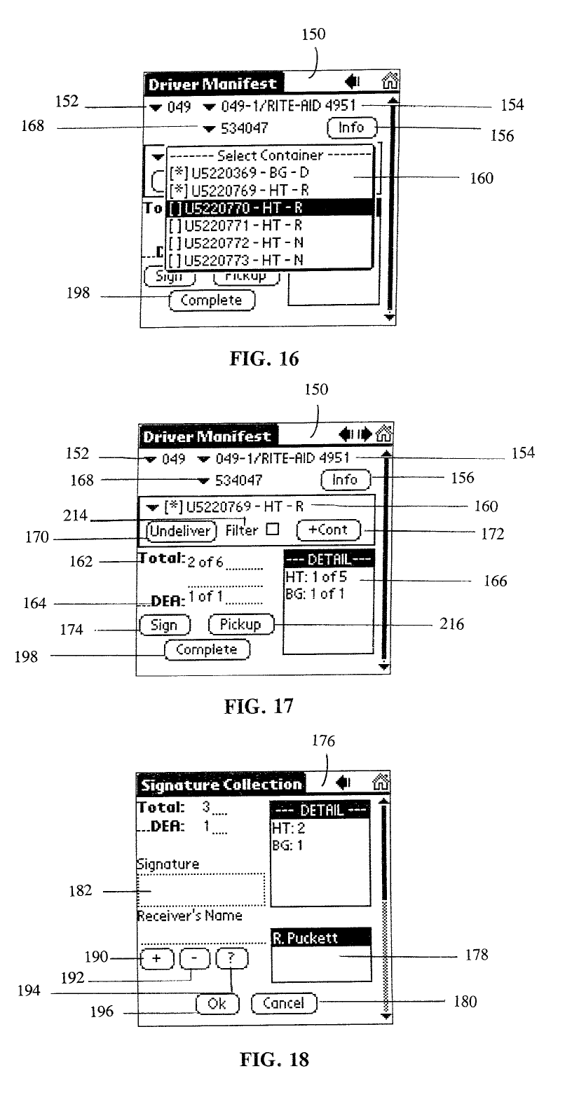

To further assist the driver with the deliveries, the driver manifest screen 150 also provides a listing of the containers placed on the delivery vehicle 14 at the distribution center 12 in a “Select Container” list box 160 as depicted in FIG. 13. The container listing shown in FIG. 16 includes the status of each container provided by the following symbols: [ ] undelivered, [*] delivered, [$] signed, [?] missing, [X] refused, [C] closed, and [O] other. The container listing also shows the container number as listed below the barcode 32 on the label 30, the container type (FT for full tote, HT for half tote, BG for bag, BP for bulk pick, CL for cooler, CP for case pick), the drug type (N for OTC over-the-counter, P or R for RX for prescription drugs, and X, B, D, E for DEA controlled narcotics), and the receiving agent's name after the signature has been captured. For example, the displayed “[*]U5220769-HT-R” represents that the half tote numbered “5220769” containing prescription drugs has been delivered but not signed.

The driver manifest screen 150 on the delivery device 40 also provides summary information about the selected stop as shown in FIG. 13. The stop summary information on the driver manifest screen 150 lists the total number of delivered and scheduled containers “Total” 162, the delivered and scheduled narcotics “DEA” 164 (the narcotics are included in the total for the Total 162), and a summary breakdown of the delivered and scheduled containers titled “Detail” 166. The “Detail” 166 identifies the container types such as half tote and full tote. The driver manifest screen 150 (see FIG. 13) also provides an account and department list box 168. By selecting a specific account, the driver can display a subset of the containers for the selected stop because some of the deliveries are made to specific accounts and departments of the retail store 16. The stop summary information will reflect this subset of the containers.

After the driver has arrived at the selected stop on the route, the driver unloads the appropriate containers for the stop 16. Typically, as the driver unloads the containers from the delivery vehicle 14, the driver uses the delivery device 40 to scan the barcode 32 on the container labels 30 as described at step 56 of FIG. 5. Once the container is scanned, the container number and other information is displayed on the line of the “Select Container” drop box 160 as illustrated in FIG. 17. For example, “[*] U5220769-HT-R” illustrated on the line of the “Select Container” drop box 160 in FIG. 17 informs the driver that container number “5220769” has been scanned.

When the container is scanned, the container is automatically considered delivered by the delivery device 40. The status flag for the container on the container line 160 is changed to “[*]” to represent delivered and the summary information on the driver manifest screen 150 is updated to reflect this delivery. Instead of scanning the container, the driver may highlight the desired container on the “Select Container” drop box 160 (see FIG. 16) and manually tap a “Delivery” button 170 to flag the container as delivered. Once the container is delivered, the delivery device 40 maintains a record of the delivery of this container at this stop.

The delivery device 40 coordinates the deliveries to reduce the chance of driver error. For example, if the driver makes a mistake delivering the container, the container may be undelivered by pressing an “Undeliver” button 170 (see FIG. 17) that is the same button as the “Deliver” button 170 prior to scanning the container. Selecting the “Undeliver” button 170 removes the delivered status flag and removes the container from the delivery record for the stop. However, the delivery device 40 provides a warning prompt and requires the driver to validate the undeliver entry. Additionally, if a container is scanned that is not for the selected route, stop, and/or account, a warning prompt will be displayed. The warning prompts provided by the delivery device 40 depend on the circumstances of the incorrect delivery. If the container is for another stop in the manifest, a warning will display the scheduled delivery location. If the container is not located in the manifest, a prompt will display asking the driver if the container should be added to the stop. If there more than one account exists for the stop, then an account must be selected before the container can be delivered. If the container was not originally on the driver manifest, the delivery device 40 will require the driver to confirm the decision to deliver the container.

The delivery device 40 also coordinates the delivery and records the delivery information of containers that are not on the driver manifest. If a container is added to a stop that has no barcode to scan, the driver must enter a customer number for the container. To enter the customer number, the driver taps a “+Cont” button 172 (see FIG. 17). A prompt then appears asking the driver to enter the container number. If the container consists of multiple units, the driver checks the “Multiple Cont” flag before taping the “+Cont” button 172. After entering the container number, the driver is prompted to enter the quantity of units delivered. These steps maintain an accurate record of the delivery in the delivery device 40.

The delivery device 40 also maintains the record of the delivery information for bulk pick containers that contain more than one container per label 30. If a container is part of a bulk pick (BP), the driver is prompted to confirm the number of pieces delivered with a message such as “Enter QTY Delivered! (10)”. The listed quantity for the “Pieces” of the bulk pick is the scheduled quantity for delivery such as 10. The driver enters the correct number delivered, and the delivery device 40 records the delivery information. If the driver entered an incorrect quantity, the driver must undeliver the shipping container and then redeliver the container.

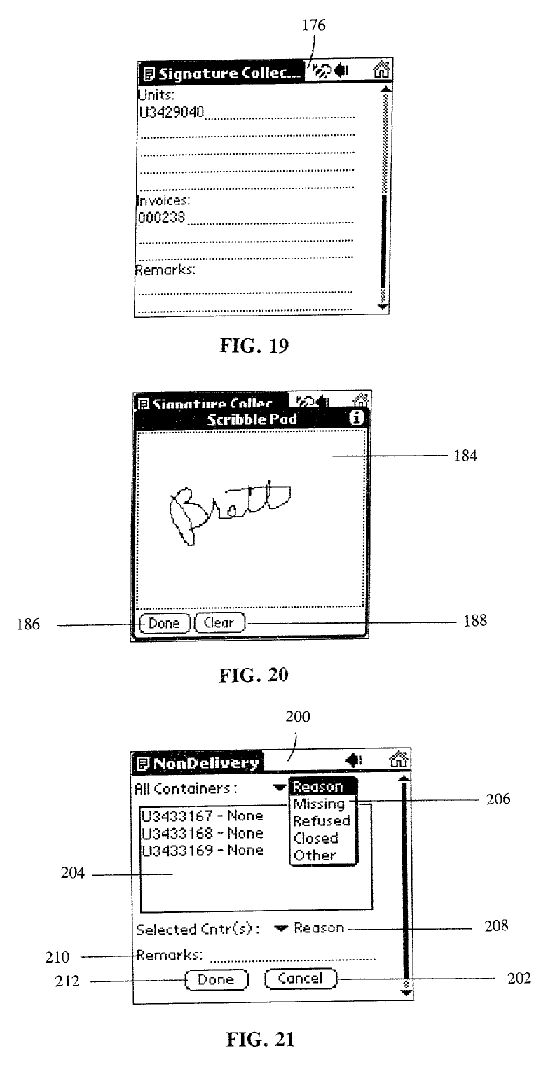

After the driver has scanned, selected or manually entered the containers delivered to the retail store 16, the driver uses the delivery device 40 to obtain a signature and name confirming the receipt of the delivery by the retail store 16. To obtain the proof of delivery signature, the driver taps a “Sign” button 174 (see FIG. 17). Selecting the “Sign” button 174 provides a signature collection screen 176 as shown in FIG. 18. The signature collection screen 176 displays a summary of all the unsigned delivered containers from the driver manifest screen 150 for this stop. For example, the displayed “Total 3; DEA 1” and “DETAIL HT:2; BG:1” represent that two half totes and one bag with controlled narcotics have been delivered to at this stop. The signature collection screen 176 also includes a receiver list box 178 containing known receiving agents or clerks' last names for the stop. As illustrated in FIG. 19, the signature collection screen 176 further includes a second page viewable by scrolling down. The second page of the signature collection screen 176 provides container and invoice details. For the example displayed in FIG. 19, the container number “U3429040” and the corresponding invoice number “000238” for the delivered container are displayed. A remarks section allows the driver to enter comments regarding the delivery that are captured in the record on the delivery device 40. If the receiving agent or clerk at the retail store is not satisfied with the containers listed, the driver uses a “Cancel” button 180 (see FIG. 18) to return to the driver manifest screen 150 without the proof of delivery signature. Upon returning to the driver manifest screen 150, the driver delivers and/or undelivers containers as desired by the receiving agent of the stop.

If the receiving agent of the retail store accepts the delivery, the driver taps a “Signature box” 182 on the signature collection screen 176 to obtain the receiving agent's signature as described at step 58 of FIG. 5. Once the signature box 182 has been selected, a scribble pad box 184 appears on the signature collection screen 176 as illustrated in FIG. 20. The receiving agent then signs their name on the graffiti area 48 of the delivery device 40. The scribble pad box 184 illustrates the signature written on the graffiti area 48. If the receiving agent approves of the signature, the driver taps a “Done” button 186 to save the image as the proof of delivery. If the receiving agent wishes to redo their signature, the driver taps a “Clear” button 188 to remove and redo the signature. After the receiving agent has accepted their signature, the display screen 46 of the delivery device 40 again displays the signature collection screen 176. On the signature collection page 176, the driver selects a name from the receiver list box 178 corresponding to the receiving agent's signature. If the receiving agent's name is not in the receiver list box 178, the driver manually adds the name to the list by tapping a “+” button 190 and entering the name. The driver may also remove a receiver name from the receiver list box 178 with a “−” button 192. The driver may further correct the spelling of a receiving agent name in the list box 178 with a “?” button 194.

After the signature has been captured and the receiving agent's name selected from the list box 178, the driver taps an “OK” button 196 to return to the driver manifest screen 150. The containers displayed for the stop are now flagged as signed (“$”) and locked to prevent any modification to the delivery information record on the delivery device 40 for those containers. Also, the receiving agent's name is appended to the container string in the “Select Container” list box 160. For example, “[$]U3769637-FT-R-magill” represents that the half tote with prescription drugs having the container number U3769637 has been delivered and signed for by Mr. Magill.

The delivery device 40 also coordinates the signature collection to reduce the chance of driver error. If the signature was captured but no receiving agent name was selected, the delivery device 40 provides a warning message to prevent the driver from exiting the signature collection screen 176 without confirming the intentional lack of the receiving agent name. Additionally, if the signature was not captured, the delivery device 40 provides a warning message to prevent the driver from exiting the signature collection screen 176 without confirming the lack of captured signature.

Upon returning to the driver manifest screen 150 from the signature collection screen 176, the driver taps a “Complete” button 198 to indicate that all of the containers for the stop have been delivered and signed for. If there are containers for the stop that have not been delivered, the delivery device 40 provides a nondelivery page 200 as depicted in FIG. 21. Upon realizing the nondelivered containers listed on the nondelivery page 200, the driver may return to the driver manifest screen 150 to deliver those containers by tapping a “Cancel” button 202. Otherwise, the delivery device 40 requires the driver to indicate a status for each of the containers listed in a nondelivered list box 204. If all of the containers listed are to be flagged with the same status, the driver taps an “All Containers: Reason” list box 206 and selects the appropriate status of “Missing,” “Refused,” “Closed,” or “Other.” If each container is to be flagged with a different status, the driver highlights one of the listed containers and uses a “Selected Cnt(s): Reason” list box 208 to enter the proper reason. If the driver selects the reason as “Other,” the driver enters remarks at a “Remarks:” line 210. After all of the containers have been flagged with their appropriate status, the driver taps a “Done” button 212 to return to the driver manifest screen 150.

The delivery device 40 provides some additional features to further assist the driver with the deliveries. On the driver manifest screen 150 as illustrated in FIG. 13 is a “Filter” checkbox 214. The driver taps the checkbox 214 to a filter setting to display in the “Select Container” list box 160 only those containers that have not been delivered at the stop. This feature helps the driver identify whether containers are missing. Instead of requiring the driver to scroll through the entire “Select Container” list box 160, the “Select Container” list box 160 with the filter setting only displays the containers that have not been delivered.

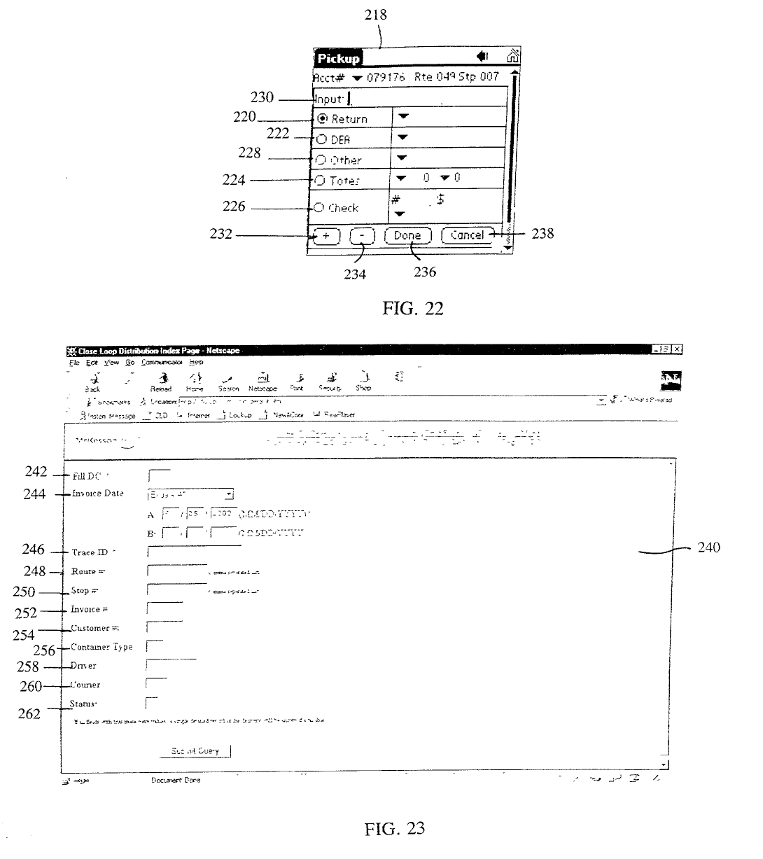

The delivery device 40 also provides a pickup feature to maintain a record of any items received by the driver from the stop, such as customer returns, DEA blanks, empty containers and/or payments. On the driver manifest screen 150, the driver selects a “Pickup” button 216 to display a pickup screen 218 as illustrated in FIG. 22. The pickup screen 218 lists the categories of returns to be received by the driver including “Return” 220 for customer returns, “DEA” 222 for DEA blanks, “Totes” 224 for a quantity of empty containers, “Check” 226 for a payment, and “Other” 228 for other items. For all categories, the driver first taps the button associated with the desired category and then enters the required information on an input line 230. After the driver has entered the appropriate information on the input line 230, the driver selects a “+” button 232 to have the entry on the input line 230 moved to the drop box to the right of the selected button. After the “+” button 232 has been tapped, the driver may again select one of the category buttons to enter other pickups including multiple entries for the same category. If the driver needs to remove one of the pickup entries, the driver selects one of the category buttons, highlights the entry in its drop box and taps a “−” button 234 to delete that pickup entry. Once all of the pickup entries are complete, the driver selects a “Done” button 236 to save the pickup entries and to return to the driver manifest screen 150. The driver uses a “Cancel” button 238 to return to the driver manifest screen 150 without saving the pickup entries.

Each of the pickup categories requires specific information to be entered on the input line 230. For “Return” 220, the driver enters a unique return identification number corresponding to the item the retail store sends back to the distribution center 12. For “DEA” 222, the driver enters a unique DEA blank number representing the narcotic the retail store sends back to the distribution center 12. For “Totes” 224, the driver enters the quantity of empty container picked up from the retail store. The quantity of containers may be entered on the input line 230 or with the drop box adjacent the “Totes” button 224. For “Checks” 226, the driver enters a check number and amount. For “Other” 228, the driver enters a description of the item.

After the driver has completed the delivery and picked up any items for the stop, the driver selects the “Complete” button 198 on the driver manifest screen 150 (see FIG. 13). If all of the containers scheduled for the stop have been delivered or accounted for with reasons for being undelivered, the driver device 40 will present the next stop to be delivered. At the next stop, the driver performs the same tasks as described for the first stop. If the driver wishes to service a different stop than the one automatically provided by the deliver device 40, the driver selects the desired stop from the “Select Stop” list box 154. If the driver wishes to service a stop not listed on the select stop list box 154, the driver selects the “Info” button 156 to obtain the stop information screen 158. At the stop information screen 158, the driver may manually enter the desired stop and add it to the manifest with the “Add” button (see FIG. 15).

After the driver has completed all of the stops on the routes for the delivery vehicle 14, the driver returns to the distribution center 12 at step 62 of FIG. 5. At the distribution center 12, the driver uploads the delivery information gathered on the delivery device 40 during the stops to the distribution center computer system 68. The upload of the delivery information file occurs in the manner as described in conjunction with FIG. 6 for downloading. The delivery device 40 is placed in the cradle 64 and the information is uploaded to the distribution center computer system 68 through cable 70.

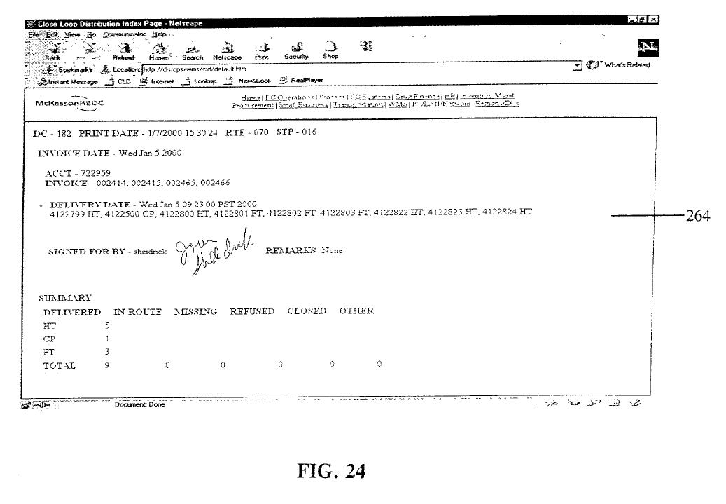

After all of the deliveries have been completed, the delivery information on delivery device 40 includes records of the status of all the containers scheduled for delivery on the delivery vehicle 14 along with proof of delivery signature and a date/time for each of the deliveries. The distribution center computer system 68 uses the uploaded delivery information to update its databases with the details of the completed deliveries. The distribution computer system 68 archives the delivery information such that it may be easily queried and retrieved. FIG. 23 illustrates a search criteria screen 240 for accessing delivery information stored within the distribution computer system databases. Delivery information may be searched for using the fields of distribution center number 242, invoice date 244, trace identification 246, route number 248, stop number 250, invoice number 252, customer number 254, container type 256, driver name 258, courier name 260 and status 262. FIG. 24 illustrates a sample search result for the delivery information 264. The displayed delivery information includes the invoice date, account number, invoice numbers, delivery date and time, proof of signature and summary of containers delivered.

The uploaded delivery information, maintained on the distribution center computer system, assists the distribution center 12 track returned or refused containers. The delivery information may be used to coordinate billing the retail stores. Furthermore, the delivery information may be used to monitor the drivers' performance. With the captured date and time information, a supervisor can determine if a driver is making unscheduled stops or unnecessary delays. The captured time information may also be used to improve the efficiency of the distribution system by assigning additional stops to the drivers. The detail record of the delivery information captured by the delivery device 40 also provides tracking of controlled narcotics. In another embodiment, the distribution center computer system 68 may provide the retail stores Internet access to the delivery information. With Internet access to the delivery information, the retail store can access proof of delivery information, such as the date, time and who signed for the delivery.

The delivery device 40 used in the distribution system 10 of the present invention provides significant benefits. First, the delivery device 40 provides paperless delivery tracking eliminating the typical paper manifests and proof of delivery signatures. The distribution system provides superior delivery accuracy because the delivery device 40 records the status of all of the containers on the delivery vehicle 14 and coordinates the driver to their proper delivery with error messages. Additionally, the delivery device 40 captures the date and time of the delivery and the name and signature of the receiving agent at the stop. This delivery information may be access by the retail stores via the Internet that eliminates the costly servicing of retail store inquiries by telephone and facsimile.

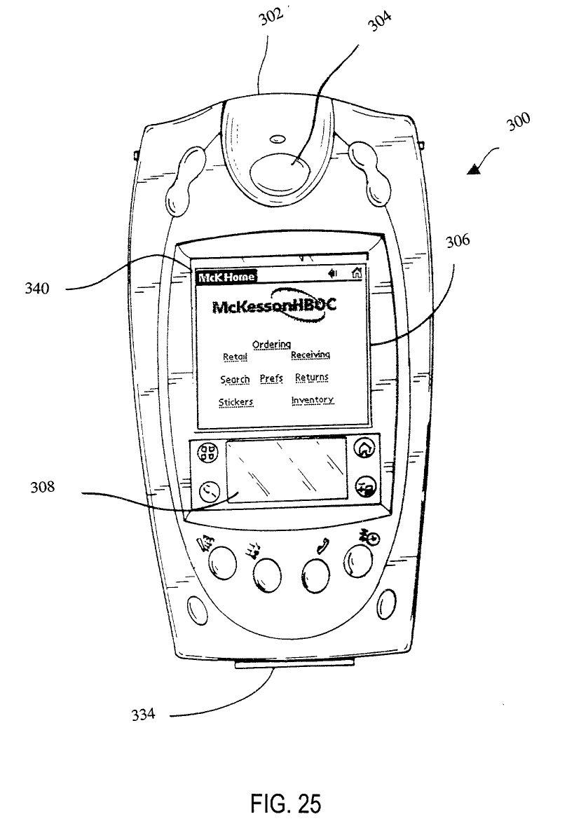

In the distribution system 10, the retail store 16 orders items from the distribution center 12 and receives the ordered items delivered by the delivery vehicle 14. In another embodiment, a non-retail entity orders and receives items. To coordinate the receiving and ordering operations of the retail store 16, the present invention provides a retail device 300 as illustrated in FIG. 25. The retail device 300 is similar to the delivery device 40 with the Palm Computing platform incorporated in the rugged housing. The retail device 300 also includes a barcode scanner 302, scanner button 304, display screen 306 and graffiti area 308 as the delivery device 40. However, the retail device 300 is programmed to assist the retail store or non-retail entity with the receiving and ordering operations of the distribution system rather than the delivery operations of the delivery device 40.

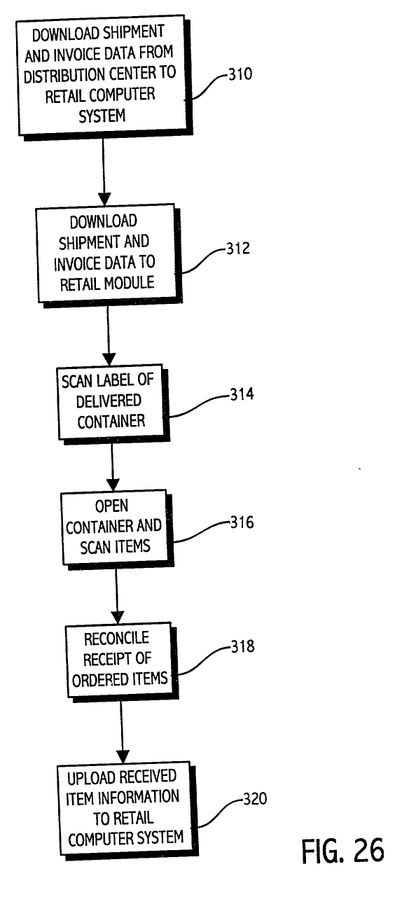

FIG. 26 generally illustrates the receiving operations performed by the retail store 16 or other entity for one embodiment of the present invention. For receiving, the retail store 16 downloads shipment and invoice data from the distribution center computer system to a retail computer system at step 310. In one embodiment, the retail computer system runs a software packaged called EconoLink™ provided by McKessonHBOC, the assignee of the present application. The EconoLink™ software coordinates receiving and ordering items from the distribution center 12. The retail computer system may be a local server or stand-alone computer located within or away from the retail store. In other embodiments where deliveries are made to entities other than retail stores, the retail computer system would be a computer system associated with the entity.

The distribution center computer system sends files containing shipment and invoice data to the retail store computer system. In one embodiment, the files are sent over the Internet. In other embodiments, the files may be transferred by other communication mediums. After the retail computer system has obtained the shipment and invoice data, the shipment and invoice data is downloaded to the retail device 300 at step 312. After the retail device 300 has the shipment and invoice data, the retail device 300 is ready to assist in the receipt of the ordered items. When the delivery vehicle 14 arrives at the retail store 16, the driver of the delivery vehicle 14 unloads the containers specified for the retail store 16. A receiving agent or clerk uses the retail device 300 to scan the barcode 32 on the label 30 of each of the container at step 314. After the container has been scanned, the receiving agent opens the container and scans each items' barcode to record receipt of the items in the container at step 316. Next the receiving agent reconciles the actual receipt of the ordered items to the shipment and invoice data on the retail device 300 at step 318. After the received items have been reconciled, the received item information on the retail device 300 is uploaded to the retail computer system at step 320. In an alternative embodiment, the received item information may be transferred from the retail device 300 to the distribution center computer system 68.

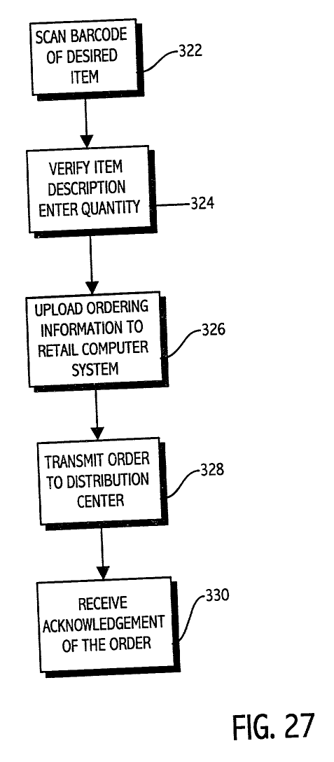

FIG. 27 generally illustrates the ordering operations performed by the retail store 16 or other entity. For ordering, the ordering agent or clerk uses the retail device 300 to scan the barcode of the desired item at step 322. Next, the ordering agent verifies the item description displayed on the retail device 300 and enters a quantity of the item to order at step 324. After all of the desired items have been ordered with the retail device 300, the ordering information on the retail device 300 is uploaded to the retail computer system with the EconoLink™ software at step 326. The retail computer system then transmits the ordering information to the distribution center computer system at step 328. In an alternative embodiment, the ordering information may be transferred from the retail device 300 directly to the distribution center computer system 68. After receiving the ordering information, the distribution center computer system sends the retail computer system an acknowledgement of the received order at step 330.

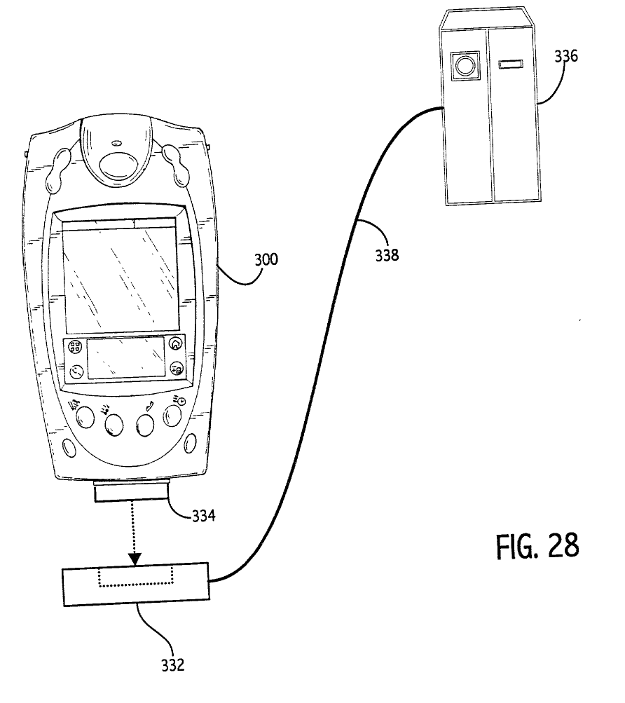

FIG. 28 depicts one embodiment for downloading the shipment and invoice data and uploading the received item and ordering information to and from the retail device 300 of steps 312, 320 and 326 in FIGS. 26 and 27. The retail device 300 connects with a cradle 332 through contacts 334 (see FIG. 25). The retail computer system 336 connects to the cradle 332 via cable 338. The shipment and invoice data, received item information and ordering information are communicated between the retail computer system 336 and the retail device 300 through the cable 338. In an alternative embodiment, the retail device 300 wirelessly communicates with the retail computer system 336. With the wireless communications, the information may be downloaded and uploaded all at once or the retail computer system 336 and the retail device 300 may frequently exchange information in real time. In an alternative embodiment, the information is communicated to a stand-alone computer with the cradle 332 and cable 338. In another embodiment, the retail device 300 communicates directly with the distribution center computer system.

The retail device 300 coordinates the receiving and ordering operations described above in conjunction with FIGS. 26 and 27. The illustrated embodiment depicts the retail device 300 programmed for customers of McKessonHBOC, assignee of the present application. In other embodiments, the retail device may be programmed for drivers of other delivery or supply services. To provide these features, the retail device 300 has a home screen 340 depicted in FIG. 25. The home page screen 340 provides the receiving agent and ordering agent of the retail store 16, or other entity with the options of “Ordering,” “Retail,” “Receiving,” “Search,” “Prefs,” “Returns,” “Stickers,” and “Inventory.” The “Ordering” option allows the ordering agent or clerk to order items from the distribution center 12. The “Retail” option enables the clerk to change the retail prices of items. The “Receiving” option allows the receiving agent to check in their orders. The “Search” option enables the ordering agent to search for items to order when their identification number is not readily known. The “Prefs” option allows the receiving agent, ordering agent and/or clerk to set preferences and defaults on the retail device 300. The “Returns” option enables the clerk to perform credit requests from delivered items. The “Stickers” option allows the clerk to request bar coded shelf tags or price stickers. The “Inventory” option enables the clerk to enter items and quantities for physical inventory verification. These options provided by the retail device 300 will be discussed below.

If the “Prefs” option is selected on the home screen 340, the retail device 300 provides a preference screen. The preference screen enables the receiving agent, ordering agent and/or clerk to customize the retail device's default settings and other preferences. For the receiving preferences, the receiving agent may set the number of days to retain a purchase order. The receiving agent may also decide to have the prices or unit of measure displayed for the scheduled quantity. Additionally, the receiving agent may select whether to transfer all of the scheduled quantity (“Scan:All” mode) or just one of the scheduled quantity to the received quantity field (“Scan:One” mode) when one of the items is scanned. Furthermore, the receiving agent may select whether to never create, always create automatically or confirm whether to create an alternative bar code from a reference page when an invalid bar code is scanned.

For the ordering preferences, the ordering agent may store an account number on the retail device 300. The ordering agent may also set to have the quantity ordered automatically set to the average quantity purchased over the past year. Additionally, the ordering agent may set the quantity ordered to round to the desired percentage of a case. Furthermore, the ordering agent may have the retail device 300 increment the existing quantity if the item is scanned more than once or the ordering agent may have the retail device 300 replace the existing quantity if the item is scanned a second time.

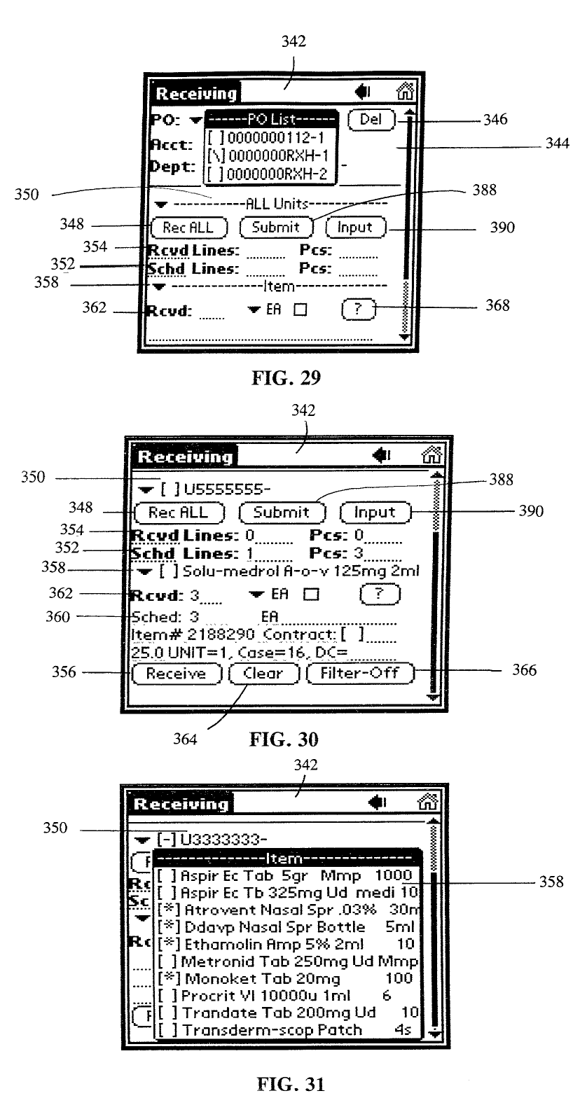

After the retail device 300 contains the invoice and shipment data of step 312 of FIG. 26, the receiving agent is ready to receive deliveries from the delivery vehicle 14. The receiving agent uses the “Receiving” option on the home screen 340 to enter a receiving screen 342 of FIG. 29. The receiving agent selects a “PO List” box 344 to ensure that the available purchase order numbers have been downloaded with the shipment and invoice information. The purchase order numbers on the “PO List” box 344 will correspond to the invoices for the delivery. The receiving agent may select a listed purchase order number to begin receiving the delivery, or more conveniently, the receiving agent just scans a barcode on the label of a delivered container to open the purchase order number automatically that corresponds to the delivered container. Once the purchase order has been selected, the receiving screen 342 lists the corresponding account and department numbers. Additionally, the receiving agent may remove a purchase order from the “PO List” box 344 by highlighting the desired purchase order and tapping a “Del” button 346.

To receive the delivered containers, the receiving agent scans the barcode 32 of the label 30 of the container with the scanner 302 of the retail device 300 at step 314 of FIG. 26. The retail device 300 provides three receiving modes: 1) “Rec ALL” that enables every item in the container to be received without scanning each item, 2) “Scan:All” that enables all of the same items in the container to be received by scanning only one of those items, and 3) “Scan:One” that enables requires the scanning of every item in the container. The receiving agent selects the “Rec:ALL” mode by tapping a “Rec All” button 348. To use the “Scan:All” mode or “Scan:One” mode, the receiving agent selects the desired mode in the receiving preferences as described above.

When the container's barcode 32 is scanned, the receiving screen 342 displays the barcode number of the container at a unit line of the “All Units” drop box 350 as illustrated in FIG. 30. The receiving screen 342 also illustrates the number of “Lines” and pieces (“Pcs”) that were invoiced in the scanned container at a scheduled (“Schd”) field 352. The receiving screen 342 also displays the number of “Lines” and pieces (“Pcs”) that have been received for the scanned container at a received (“Rcvd”) field 354. If the receiving agent wishes to quickly to record the receipt of the items within the scanned container, the receiving agent sorts the container by each item counting the number of items to ensure the displayed numbers for the scheduled field 290 conform to the number of items within the container. If the scheduled quantities match the quantities present within the container, the receiving agent selects the “Rec ALL” button 348 to record the receipt of the items. Similar to delivery device 40 recording delivery information, the retail device 300 records information regarding the receipt of the delivery.

The retail device 300 assists the receiving agent to reduce the possibility of error. In the “Rec All” mode, the retail device 300 may be configured to set a “high value” preference. With the “high value” preference, all containers and items with high dollar values would include a “[!]” label in the unit line 350. The “high value” preference instructs the receiving agent to individually scan the barcodes of all high price items to specifically record the receipt of the expensive items before selecting a “Receive” button 356 to record the receipt of the items.

In the “Scan:All” mode, the receiving agent receives the delivered/ordered items by scanning only one of each item within the container. When the barcode 32 of the container label 30 is scanned, the receiving screen 342 displays the contents of the container in an “Item” list box 358 as illustrated in FIG. 31. For the “Scan:All” mode, the receiving agent then scans the barcode of one of the items within the container to display that item's description on the top of the “Item” list box 358 as displayed in FIG. 30. Additionally, the receiving screen 342 displays the quantity invoiced for the scanned item at an item “Schd” field 360. Below the item “Schd” field 360 is the item number and other item details such as unit size and case size. After counting the quantity of the scanned item present within the container, the receiving agent compares this number to the quantity scheduled on the item “Schd” field 360. If the quantity of item within the container matches the scheduled quantity, the receiving agent taps the “Receive” button 356 to record the receipt of the items. If the quantity listed in the item “Schd” item field 360 does not match the quantity within the container, the receiving agent enters the proper number directly within a item “Rcvd” field 362 before tapping the “Receive” button 356. If the quantity on the item “Rcvd” field 362 is incorrect, the receiving agent selects the item “Rcvd” field 362, taps a “Clear” button 364 and scans each of those same items within the container. The receiving agent then continues to scan to the other items within the container until all items within the container have been recorded as received.

In the “Scan:One” mode, the receiving agent receives the delivery/order by scanning each and every item within the container. As explained above, when the barcode 32 of the container label 30 is scanned, the receiving screen 342 displays the contents of the container in the “Item” list box 358. For the “Scan:One” mode, the receiving agent then scans the barcode of one of the items within the container to display that item's description on the top of the “Item” list box 358. Additionally, the receiving screen 342 displays the item “Schd” field 360 that reflects the quantity invoiced for the scanned item. Moreover, the item “Rcvd” field 362 is incremented by one each time another same type of item is scanned. For large quantities, instead of scanning each item once to increment the received item field 362, the receiving agent may count the number of those items within the container and enter this quantity directly in the “Rcvd” field 362. Using the “Scan:One” mode allows the retail store to verify receipt of every item in the container by separately scanning each item's barcode. The “Scan:One” mode provides the greatest accuracy to insure all of the items invoiced are actually received at the retail store 16. After the receiving agent has scanned each of the items in the container and the received quantity is correct, the receiving agent presses the “Received” button 356 to store the receipt information on the retail device 300.

When the barcode 32 of the container label 30 is scanned, the receiving screen 342 displays the contents of the container in the “Item” list box 358 as illustrated in FIG. 31. The “Item” list box 358 displays descriptions of the items within the scanned container. In some embodiments, the unit of measure information or pricing information is also displayed. The items in the “Item” list box 358 are listed alphabetically and include a status field enclosed by brackets. Items with an “[*]” have already been scanned, correct quantity identified and received; otherwise, the items listed without the “[ ]” have not been received.

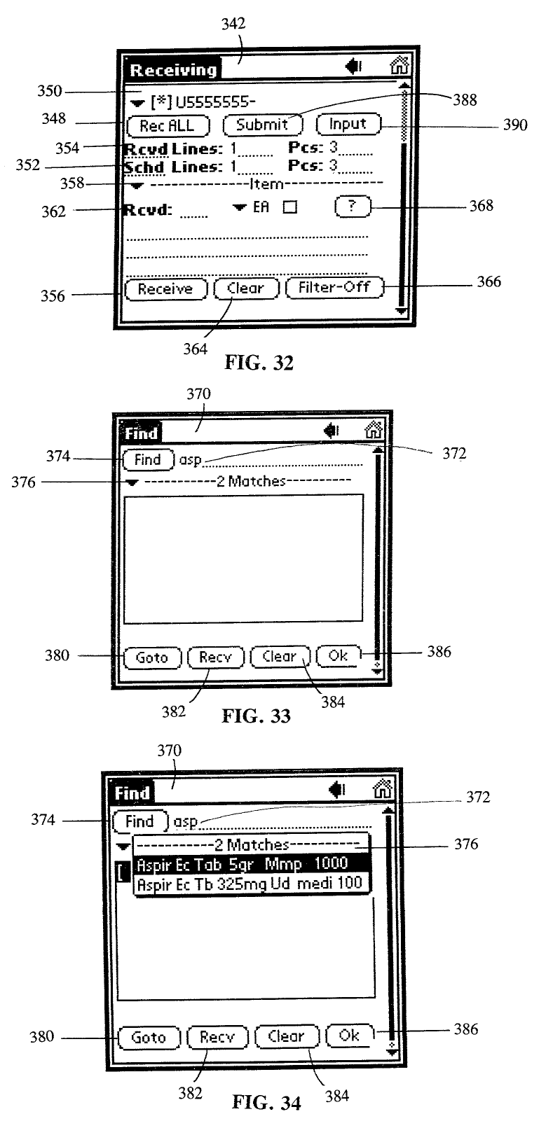

The retail device 300 includes features to assist the receiving agent to reduce the possibility of error. One such feature is a filter feature. Once the receiving agent has scanned all of the scannable items in the container, the receiving agent uses a “Filter Off/On” feature on the retail device 300. By selecting the “Filter Off/On” button 366 to the “On” setting, only the items not yet received and items with discrepancies will be displayed in the “Item” list box 358. Some items in the container may not be scannable, so the receiving agent manually selects those items on the “Item” list box 358. When an item is selected, the description, receiving quantity and other information will appear on the receiving screen 342 in the same manner as for scanned items. After manually selecting the unscanned item, the receiving agent validates the quantity and records the receipt of the item with the “Receive” button 356 in the same manner as for scanned items. Once all of the items in the container have been selected, their quantities validated and receipt recorded, the container will be flagged with the “[*]” at the “Units” line 350 illustrated in FIG. 32.

The retail device 300 also provides a find feature to help the receiving agent find items not yet received. By tapping a “?” button 368, the retail device 300 displays a find screen 370 as depicted in FIG. 33. On the find screen 306, the receiving agent enters the item description, the UPC/NDC number or the Economost™ item reference number used by the distribution system of the item to find. If searching by the item description, only the first couple of letters need to be entered as shown in FIG. 33 with “asp” 372 for aspirin. Once the description or number(s) have been entered, the receiving agent selects a “Find” button 374 and the available matches, if any, are displayed in a “Matches” list box 376 as illustrated in FIG. 34. If one of the matches corresponds to the desired item, the receiving agent selects that item from the “Matches” list box 376.

After selecting one of the matches, the find screen 370 displays the item description on the top line of the “Matches” list box 376. The find screen also lists the container holding the listed quantity 378 of that item below the top line of the “Matches” list box 376 as illustrated in FIG. 35. For example, the displayed “[ ]0000000-1::U333333 (9EA)” 378 represents that nine Aspirin with the item number 0000000RXH-1 are found in container number U333333. Once the item is found, the receiving agent has four options. The receiving agent then may select a “Goto” button 380 that will carry this item back to the receiving screen 342 where the receiving agent may record the receipt of the item. The receiving agent may select a “Recv” button 382 that records the receipt of the item at the find screen 370. The receiving agent may select a “Clear” button 384 to initiate a new find search, and the receiving agent may tap an “OK” button 386 to go back to the receiving screen 342 without the search results.

Some items within the scanned container may have a damaged or missing barcode. These items are placed to the side until the remainder of the delivery has been received. The receiving agent then manually enters their receipt on the retail device 300 using the “Filter On” feature to identify items not yet received. Additionally, some items may have barcodes when scanned that are not identified by the retail device 300. The receiving agent may add the unrecognized bar code to the database by scanning the bar code and then selecting the item from the “Item” list box 358 and tapping the “Schd” field 360.

To reduce errors in the receiving process, the retail device 300 provides a warning if a scanned item from the delivery does not match any of the items on the purchase order. If the scanned barcode does not match any ordered item, a warning beep sounds and the item will not appear on the top line of the “Item” list box 358 of the receiving screen 342. The item in the container may have been incorrectly placed in the container by the distribution center 12. To fix this discrepancy, the receiving agent uses a “Returns” option on the home page 340 as will be described below.

After the receiving agent has scanned all of the items in the container, the receiving agent uses the retail device 300 to find any discrepancies. By using the filter feature, only the items that have not been recorded as received will be displayed in the “Item” list box 358. Discrepancies include both items that were not received and items whose quantities received did not agree with the purchase order quantities. Items that were not included will have the status flag “[?]” in the “Item” list box 358. The receiving agent should review these discrepancies before completing the receiving process for the container. If discrepancies are present, the bracket next to the unit number of the container on the top line of the “Unit” list box 350 will contain a number sign “[#].”

The receiving agent performs the receiving process for each container of the order. After all of the containers have been received and any discrepancies reviewed, the receiving agent selects a “Submit” button 368 to lock in the record on the retail device 300 of the received items and quantities. After pressing the “Submit” button 368, the PO status flag is set to “[*]”, and the retail device 300 will not accept any further modifications concerning the purchase order. After the “Submit” button 388 is tapped, the retail device 300 displays the home screen 340.

After all of the containers have been received, the receiving agent uploads the receiving information on the retail device 300 to the retail computer system 336 running the EconoLink™ software. In another embodiment, the receiving information is uploaded to a stand-alone computer. The uploading is performed as described above in conjunction with FIG. 28. After the receiving information has been received on the retail computer system 336, the receipts and discrepancies from the delivery may be searched and viewed with the EconoLink™ software in a similar manner as described in conjunction with FIGS. 23 and 24.

The receiving procedures for the distribution system of the present invention provide significant advantages. The retail device 300 increases the productivity and accuracy of the receiving agent receiving the delivered items. The retail device 300 allows the deliveries to be quickly reviewed and validated. The retail device 300 also reduces the training required for the receiving agent. Moreover, the retail device 300 maintains the electronic record that may be searched and consulted when reviewing billing information.

The retail device 300 also coordinates the ordering procedures for the retail store 16 or other entity. By selecting the “Ordering” option on the home page screen 340, the order creation screen 400 appears on the display screen 306 of the retail device 300 as depicted in FIG. 36. To start a new purchase order, the ordering agent highlights a “New PO” line 402 and then selects an “Edit” button 404. To resume a previously prepared but non-finalized purchase order, the ordering agent highlights the desired purchase order in a “PO” list box 406 and selects the “Edit” button 404. Non-finalized orders are marked “EDT” in the “PO” list box 406. After the “Edit” button 404 has been selected, the retail device 300 displays a PO direct entry screen (hereinafter “ordering screen”) 408 as depicted in FIG. 37. The ordering screen 408 displays an account number and department number for the retail store or entity that correspond to the account and department numbers used with the EconoLink™ software or stand alone numbers. These numbers may be selected from their drop down lists 410 and 412. If the purchase order is new, the ordering agent enters a purchase order name or number at a “Enter PO:” line 414 to identify the purchase order. The ordering agent may enter any name or number such as “12345” as shown in FIG. 37.

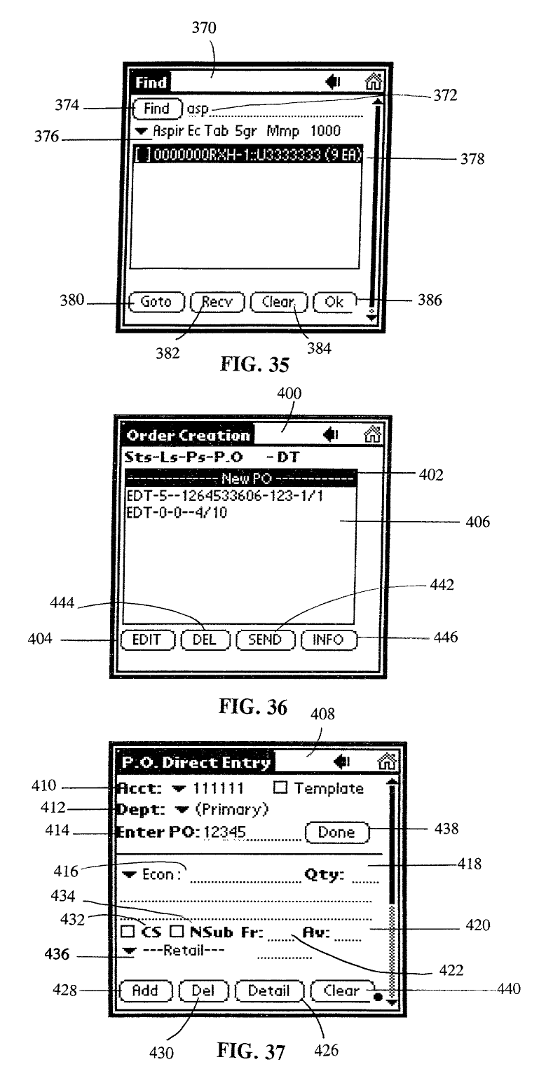

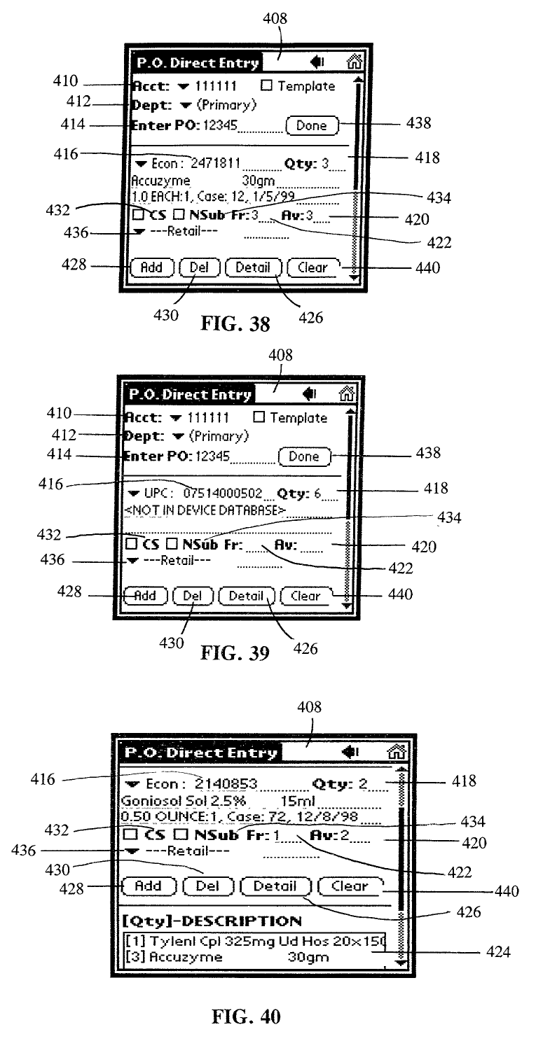

To generate the purchase order, the ordering agent uses the scanner 302 on the retail device 300 to scan the Economost™ number barcode from the shelf labels or the UPC/NDC from the barcodes on the actual items at step 322 of FIG. 27. The retail device 300 automatically recognizes each kind of barcode and their associated item. In one embodiment, the retail module includes an electronic catalog containing historical data on what the customer has order in the past. If the scanned item is included in a retail store's database, the item information will be displayed as shown in FIG. 38 at item line 416. The item information includes the item description and unit of measure information. For example, the displayed “Econ: 2471811 Accuzyme 30 gm” represents that the Economost™ number is 2471811 which corresponds to 30 gm Accuzymes. Items, included in the retail store's database, are items ordered within the last year. If the scanned item is not in the database, the retail device 300 displays a message “<NOT IN DEVICE DATABASE>” below item line 416 as shown in FIG. 39. Even when this message appears, if the item is available from the distribution center, the order will be accepted, and the item information will be listed on the purchase order imported to the retail computer system 336 with the EconoLink™ software.

The retail device 300 provides two preferences for determining the quantities to order for the scanned item. One preference is a “Use Average” method that automatically suggests order quantities in a quantity field 418 based on an average quantity of the item ordered in each shipment over the last year. In the other preference, the quantity field 418 is left blank and the quantity will be incremented by one each time the item's barcode is scanned. The ordering agent uses the keyboard of Graffiti area to directly enter or change a quantity of the scanned item. To further assist with ordering, the retail device 300 displays the average quantity ordered for that item at an “Av” line 404 and the frequency at which the item was order during the last year at a “Fr” line 422.

As the ordering agent scans the bar codes of items to order, the most recently ordered items will be displayed in an order summary list box 424 as illustrated in FIG. 40. The order summary list box 424 displays the item description and quantity ordered. Highlighting items in the order summary list box 424 will display additional item details. Also, more details regarding the highlighted item can be displayed by selecting a “Detail” button 426 to provide an item detail screen similar to the one illustrated in FIG. 43.

The ordering agent may modify ordered items listed in the ordered summary list box 424. By highlighting the ordered item in the ordered summary list box 424, the ordered quantity may be incremented by pressing an “Add” button 428. A “Del” button 430 is used to remove the highlighted item from the order. If an item is not scannable, the ordering agent may manually enter the UPC/NDC bar code or Economost™ number by entering the number on the item line 416 and tapping the “Add” button 428. Prior to entering the number, the ordering agent enters whether the number is the UPC/NDC or Economost™ number.

The retail device 300 provides features to assist with the ordering procedures. The ordering screen 408 provides a “CS” check box 432. When a check appears in the “CS” check box 432, the order will be placed in cases instead of the default of individual items. For the “CS” mode, the default quantity will be one case. The order screen 408 also provides a “Nsub” check box 434. The “Nsub” check box 434 may be checked to instruct the distribution center 12 not to substitute a different item for the item ordered. The order screen 408 also provides a “Retail” list box 436. With the “Retail” list box 436, the ordering agent of the retail store 16 requests the distribution center 12 to change the retail or list price printed on the stickers shipped with the ordered item. To change the price associated with the ordered item, the ordering agent highlights one of the price categories and then enters in the new price. The retail price change requests will be described below in conjunction with the “Retail” option on the home screen 340.

When the ordering agent has ordered all of the desired items, the ordering agent reviews the purchase order by scrolling through the order summary list box 424. If the purchase order should be placed with the distribution center, the ordering agent selects a “Done” button 438 to lock in the purchase order stored on the retail device 300. Once the “Done” button 438 has been tapped, the retail device 300 returns to the order creation screen 400. To return to the order creation screen 400 without saving the order entries, the ordering agent taps a “Clear” button 440.

After purchase order has been entered on the ordering screen 408, the order creation screen 400 will display the purchase order record 406 as shown in FIG. 36. The order creation screen 400 displays the status (“Sts”) of “EDT” for edited purchase orders or “SND” for purchase orders sent to the retail computer system 336. The order creation 400 also displays the number of lines (“Lns”), number of pieces (“Ps”), purchase order number (“P.O.”), and the date of the inventory grouping (“DT”) for the purchase order record. If the ordering agent wishes to send the purchase order record to the retail computer system 336, the ordering agent highlights the purchase order record and taps a “Send” button 442. The system of FIG. 28 is used to send the purchase order record to the retail computer system 336. In another embodiment, the purchase order record 15 uploaded to a stand-alone computer. Once the purchase order has been sent, the status field changes from “EDT” to “SND.” To delete the purchase order record, the ordering agent highlights the purchase order and taps a “Del” button 444. The order creation screen 400 also provides a “Info” button 446 that provides instructions on the ordering procedures.

Once the retail computer system 336 or stand-alone computer receives the purchase order, a manager may review the contents of the purchase order. If the purchase order contains the correct items to order from the distribution center 12, the purchase order is transmitted to distribution center 12. In one embodiment, the retail computer system uses the EconoLink™ software that coordinates transmission of the purchase order to the distribution center computer system 68 via the Internet. Once the distribution center computer system 68 receives the purchase order, the distribution center computer system sends the retail computer system an acknowledgement of the receipt of the purchase order by email. In another embodiment, the distribution center computer system 68 sends a stand-alone computer associated with the ordering agent the email. In other embodiments, the purchase order transmission and acknowledgment may be done with any type of communication such as facsimile or mail.

In one embodiment, the retail module 300 allows the customer or retail store to create and save purchase order templates for standard, regularly ordered items. For example, if a retail store orders the same items every week, the ordering agent may create a purchase order template including the items and quantities typically ordered. With the template, the ordering agent does not need to scan or select items. Rather, the items and quantity are already listed in the purchase order template. The ordering agent simply reviews the items and quantities listed on the template and makes any desired changes to create a new purchase order.

In one embodiment, the ordering agent creates the purchase order template by selecting a previously created purchase order and setting its status as a template. The status may be set for a highlighted purchase order listed on the order creation screen 400 by tapping a “Temp” button (not shown). In other embodiments, the template may be created with the retail computer system or with a stand-alone computer system and downloaded onto the retail module. Purchase order templates are marked “TEMP” in the “PO” list box 406.

If the ordering agent wishes to use the purchase order template, the ordering agent highlights the desired template in the “PO” list box 406 on the order creation screen 400 and then selects an “Edit” button 404. After the “Edit” button 404 has been selected, the retail device 300 displays the ordering screen 408. On the ordering screen 408, the ordering agent enters a purchase order name or number at the “Enter PO:” line 414 to identify the new purchase order being created using the template. Instead of scanning or selecting items to order, the ordering agent reviews the items and quantities listed in the order summary list box 424 on the template. The ordering agent may change the listed quantities, remove items or add items in the manner described above. After all of the desired items are included in the purchase order created from the template, the ordering agent selects the “Done” button 438 as described above. The newly created purchase order may be uploaded to the retail computer system or a stand-alone computer system as described above.

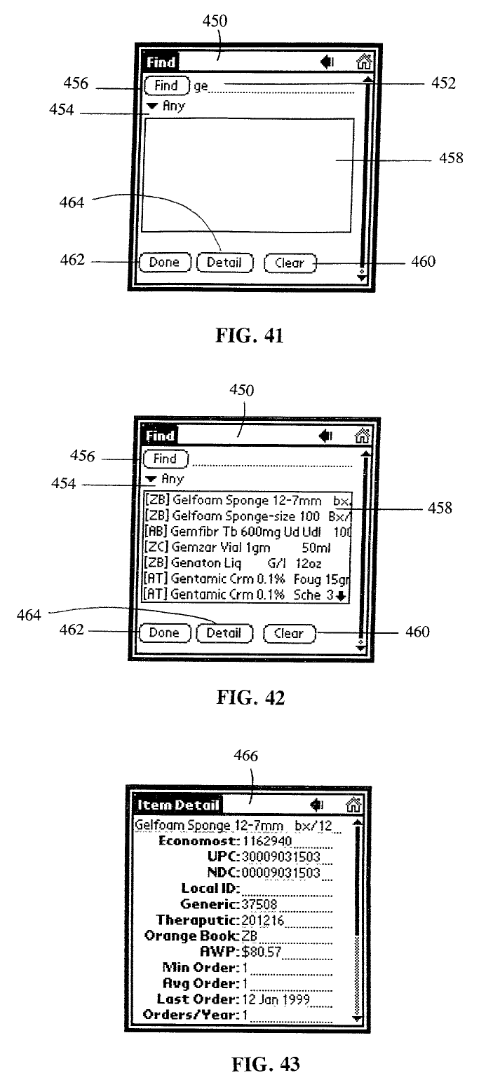

If the “Search” option was selected on the home screen 340, the retail device 300 will display a find screen 450 as illustrated in FIG. 41. The item search feature on the retail device 300 is similar to the find feature in the receiving feature of the retail device. The item search feature allows the clerk or anyone using the retail module to find items by entering item description, the UPC/NDC number, the Economost™ number, generic code or therapeutic code. If searching by the item description, only the first couple of letters need to be entered as shown in FIG. 41 with ge 452. The clerk may also set the search criteria with the search criteria drop box 454. The search criteria drop box 454 list search options including any, item description, Economost™ number, UPC, NDC, generic code, and therapeutic code.

Once the description or number(s) and search criteria have been entered, the receiving agent taps a “Find” button 456 and the available matches, if any, are displayed in an matches list box 458 as illustrated in FIG. 42. To begin a new search, the clerk selects a “Clear” button 460. The clerk exits the item search feature by tapping a “Done” button 462. By highlighting one of the listed matches and tapping a “Detail” button 464, the retail device 300 displays an item detail screen 466 as illustrated in FIG. 43. The item detail screen 466 provides the Economost number, UPC number, NDC number, local identifier, generic code, therapeutic code and orange book code. Additionally, the item detail screen 466 lists the price of the item, the minimum quantity orderable, the average ordered quantity, the date of the last order and the number of orders for this item per year. The clerk may capture the information from the item search and transfer the highlighted item to the order screen 408. In one embodiment, the clerk selects an “Order” button (not shown) to transfer the highlighted item to the ordering screen 408. In an alternative embodiment, the clerk may use the copy and paste features of the Palm Computing platform to transfer the item to the order screen 408.

The ordering procedures for the distribution system 10 of the present invention provide significant advantages. The retail device 300 improves the productivity and accuracy of the retail store 16. The ordering procedures with the retail device 300 provide faster and easier training of personnel. The retail device 300 reduces the likelihood of erroneous orders because the retail device 300 provides the last date ordered and average quantity ordered for the item. The retail device 300 also provides extensive item details on the screens allowing the ordering agent to easily verify the desired item. The retail device 300 is also very portable allowing the ordering agent to roam freely about the retail store 16 to generate the order.

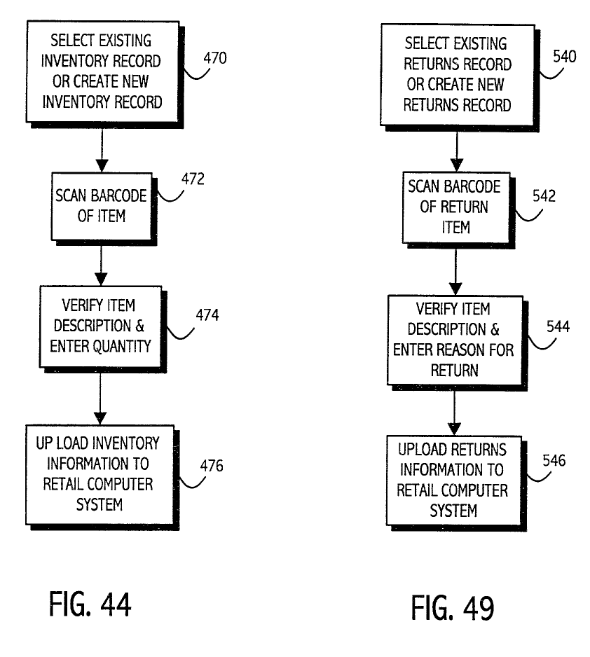

If the “Inventory” option was selected on the home page screen 340, the clerk or anyone associated with the entity performs an inventory process with the retail device 300. FIG. 44 generally illustrates one embodiment of the inventory procedures performed with the retail device 300. First, the clerk selects an existing inventory record to modify or creates a new inventory record on the retail device 300 at step 470. Next, the clerk scans the barcode of an item at step 472. At step 474, the clerk verifies the item description displayed on the retail device 300 and enters a quantity of the item as inventory. After all of the desired items have been entered as inventory with the retail device 300, the inventory information on the retail device 300 is uploaded to the retail computer system 336 at step 476. In an alternative embodiment, the inventory information on the retail device 300 may be uploaded to a stand-alone computer.

When the “Inventory” option is selected on the home screen 340, the retail device 300 displays a inventory main screen 478 as illustrated in FIG. 454. On the inventory main screen 478, the clerk may create a new inventory record or access an existing inventory record. To edit an existing inventory record, the clerk highlights one of the listed inventories under a “New Inventory” line 480 and taps an “Edit” button 482 to display an inventory header screen as will be described in conjunction with creating a new inventory record. To create the new inventory record, the clerk highlights the “New Inventory” line 480 and taps a “Edit” button 482 to display an inventory header screen 484 as illustrated in FIG. 46. For the inventory record, the clerk selects the proper account number from an “Acct” drop box 486, selects the proper department number from a “Dept” drop box 488 and selects the user name from a “User” drop box 490. These drop boxes 486, 488 and 490 are populated with the appropriate numbers and identifiers for the retail store 16 as used with the Econolink™ software on the retail computer system 336. To return to the inventory main screen 478, the clerk taps a “Done” button on the inventory header screen 498.

On the inventory header screen 484, the clerk enters a reference number at a “Reference #” line 492 to identify the inventory record. The clerk then enters whether the inventory type is an opening, closing or value type inventory from an “Inventory Type” drop box 494. After entering the type of inventory, the clerk taps a “Inventory” button 496 to display an inventory entry screen 498 as illustrated in FIG. 47. On the inventory entry screen 498, the clerk performs the inventory entries for the selected department with the scanner 302 on the retail device 300. The clerk simply scans the barcodes from the shelf labels for the Economost™ numbers or the UPC/NDC barcodes on the actual items. The retail device 300 automatically recognizes each kind of barcode and their associated item.

If the scanned item is included in a retail store's database, the item information, including product identifier (either Economost™ number or UPC/NDC number), product description, unit of measure, case size, and last order date, will be displayed in an item information field 500. If the scanned item is not in the database, the retail device 300 displays a message “<NOT IN DEVICE DATABASE>” in the item information field 500. Even when this message appears, if the item is available from the distribution center, the inventory record will be accepted. After checking the item information to verify that this is the item, the clerk enters a quantity of the item in a quantity (“Qty”) field 502. The inventory entry screen 498 includes a keyboard 504 to assist the clerk with entering numbers for the inventory process. After the quantity of the item has been entered, the inventory entry screen 498 displays the value of the inventory item at a “Value” field 506.

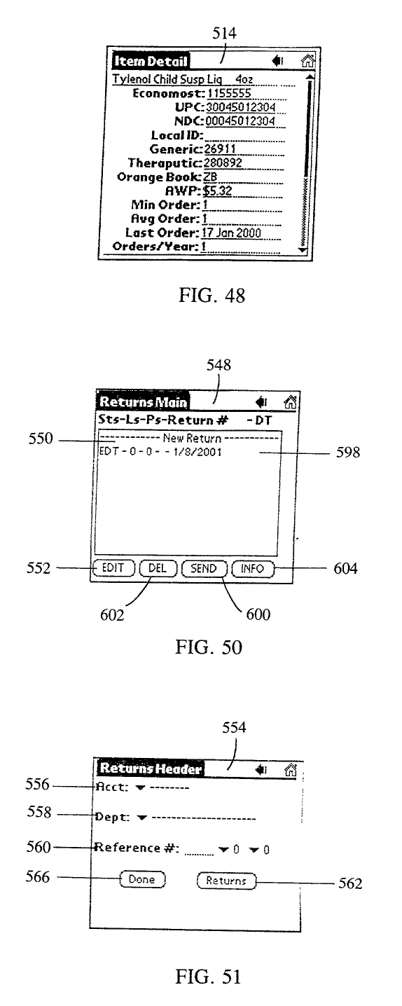

In addition to scanning barcodes, the clerk may manually enter the Economost™ number or UPC/NDC number of the item directly on an item line 508 using the keyboard 504 or graffiti area 306 of the retail device 300. Prior to entering the item number, the clerk sets whether the number is the Economost™ number or UPC/NDC number using a drop box 510. After verifying that the item number is correct, the clerk enters a quantity of the listed item in the “Qty” field 502. To ensure that the scanned item or manually entered number matches the inventory item, the clerk taps a “Detail” button 512 to display an item detail screen 514 as illustrated in FIG. 48. The item detail screen 514 provides the Economost™ number, UPC number, NDC number, local identifier, generic code, therapeutic code and orange book code. Additionally, the item detail screen 514 lists the list price of the item, the minimum quantity orderable, the average ordered quantity, the date of the last order and the number of orders for this item per year. When the clerk finishes reviewing the item detail screen 514, the clerk taps a “Done” button (not shown) to return to the inventory entry screen 498.

After reviewing the item details and entering the quantity of the item, the clerk taps an “Add” button 516 to add an entry corresponding to this item to the inventory record. If the clerk wishes to remove this item entry from the inventory record, the clerk taps a “Del” button 518. To continue with the inventory process, the clerk scans more items and updates their quantities. The clerk may review previous inventory entries by using the arrows on the second page of the inventory entry screen 498 to see the description of those previous inventory entries. To complete the inventory entries and save the entered information, the clerk taps a “Done” button 520 to return to the inventory main screen 478. If the clerk wishes to return to the inventory main screen 478 without saving the inventory entries, the clerk taps a “Clear” button 522. To return to the inventory header screen 484, the clerk taps a “Header” button 524 on the inventory entry screen 498.

The retail device 300 provides features to assist in the inventory procedures. The inventory entry screen 498 provides a “ChkItm” check box 526. If the “Chkltm” box 526 is selected, the retail device 300 checks for duplicate entries of the same item. If an item is scanned and/or manually entered more than once, the retail device 300 either adds one to the prior quantity or replaces the prior quantity with a newly entered quantity depending on the preferences set for the retail device 300. The retail device 300 also provides a “(-)” check box 528. If the “(-)” box 528 is selected, the quantity entered by the clerk will to subtracted from the previous inventory quantity for the item.

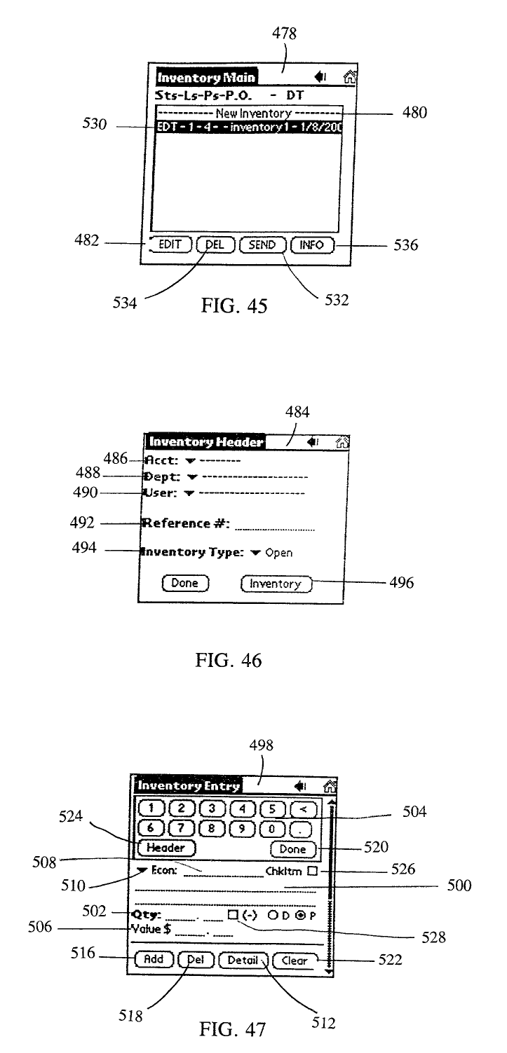

After all of the inventory entries have been entered on the inventory entry screen 498 and the “Done” button 520 selected, the inventory main screen 478 displays the newly entered inventory record 530 as shown in FIG. 45. The inventory main screen 478 displays the status (“Sts”) “EDT” for edited inventory record or “SND” for sent inventory record. The inventory main screen 478 also displays the number of lines (“Lns”), number of pieces (“Ps”), purchase order number (“P.O.”), and the date of the inventory grouping (“DT”). If the clerk wishes to send the inventory record to the retail computer system 336 or a stand-alone computer, the clerk highlights the inventory record and taps a “Send” button 532. The inventory record is sent to the retail computer system 336 or the stand-alone computer using the system described above in conjunction with FIG. 28. Once the inventory record has been sent, the status field changes from “EDT” to “SND.” To delete the inventory record, the clerk highlights the inventory record and taps a “Del” button 534. The inventory main page 478 also provides a “Info” button 536 that provides instructions on the inventory procedures.

The inventory procedures for the distribution system 10 of the present invention provide significant advantages. The retail device 300 improves the productivity and accuracy of the retail store 16. The inventory procedures with the retail device 300 provide faster and easier training of personnel. The retail device 300 reduces the likelihood of erroneous inventory numbers because the retail device 300 provides inventory records with the last date ordered and average quantity ordered for the item. The retail device 300 also provides extensive item details on the screens allowing the clerk to easily verify the inventory item. The retail device 300 is also very portable allowing the clerk to roam freely about the retail store 16 to generate the inventory. Moreover, management of the retail store can readily access and review the inventory records on the retail store computer system 336.

If the “Returns” option was selected on the home page screen 340, the clerk or anyone associated with the entity performs a returns process with the retail device 300. FIG. 49 generally illustrates one embodiment of the returns procedures performed with the retail device 300. First, the clerk of the retail store selects an existing returns record to modify or creates a new returns record on the retail device 300 at step 540. Next, the clerk scans the barcode of a return item at step 542. At step 544, the clerk verifies the item description displayed on the retail device 300 and enters a reason for the return. After all of the desired items have been entered as returns with the retail device 300, the returns information on the retail device 300 is uploaded to the retail computer system 336 at step 546. In an alternative embodiment, the returns information may be transferred directly from the retail device 300 to the distribution center computer system 68 or a stand-alone computer.

When the “Returns” option is selected on the home screen 340, the retail device 300 displays a returns main screen 548 as illustrated in FIG. 50. On the returns main screen 548, the clerk may create a new returns record or edit an existing credit returns record. To edit the existing returns record, the clerk highlights one of the listed returns under a “New Return” line 550 and taps an “Edit” button 552 to display a returns header screen as will be described in conjunction with creating a new returns record. To create the new returns record, the clerk highlights the “New Return” line 550 and taps the “Edit” button 552 to display the returns header screen 554 as illustrated in FIG. 51. The clerk selects the proper account number from an “Acct” drop box 556 and selects the proper department number from a “Dept” drop box 560. These drop boxes 556 and 558 are populated with the appropriate numbers the retail store 16 as used with the Econolink™ software on the retail computer system 336.

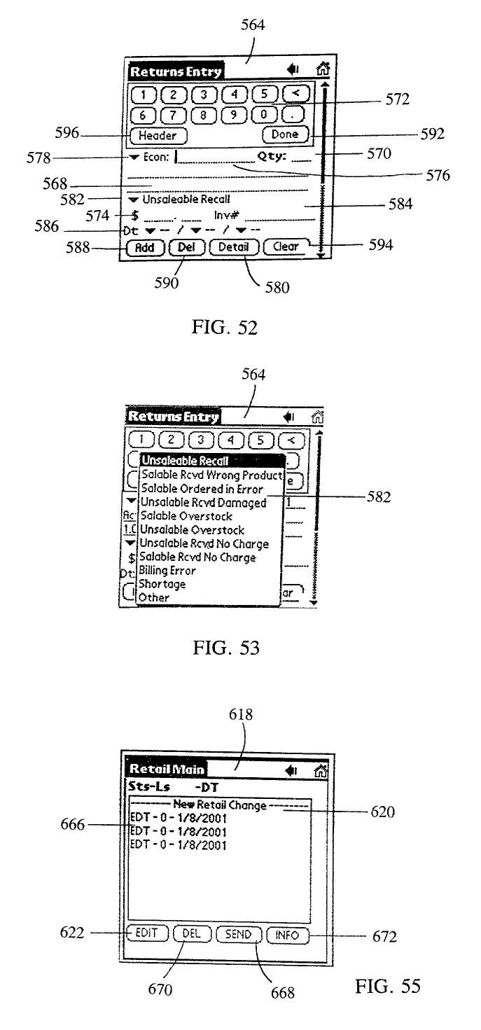

On the returns header screen 554, the clerk enters a four digit reference number and a two digit sequence number at a “Reference #” line 560 to identify the returns record. After entering the reference number and sequence number, the clerk taps a “Returns” button 562 to display a returns entry screen 564 as illustrated in FIG. 52. If the clerk wishes to go back to the returns main screen 548, the clerk taps a “Done” button 566. On the returns entry screen 564, the clerk enters the return items for the selected department with the scanner 302 on the retail device 300. The clerk simply scans the barcodes for the Economost™ numbers from the shelf labels or the UPC/NDC barcodes on the actual items. The retail device 300 automatically recognizes each kind of barcode and their associated item.

If the scanned item is included in a retail store's database, the item information, including product identifier (either Economost™ number or UPC/NDC number), product description, unit of measure, case size, and last order date, will be displayed in an item information field 568. If the scanned item is not in the database, the retail device 300 displays a message “<NOT IN DEVICE DATABASE>” in the item information field 568. Even when this message appears, if the item is available from the distribution center 12, the returns record will be accepted. After checking the item information, the clerk enters a quantity of the return item in a “Qty” field 570. The returns entry screen 564 includes a keyboard 572 to assist the clerk with entering numbers for the returns process. After the quantity of the item has been entered, the returns entry screen 564 displays the value of the return items at a value “$” field 574.

In addition to scanning barcodes, the clerk may manually enter the Economost™ number or UPC/NDC number of the return item directly on an item line 576 using the keyboard 572 or graffiti area 306 of the retail device 300. Prior to entering the item number, the clerk sets whether the number is the Economost™ number or UPC/NDC number using the drop box 578. The clerk then enters a quantity of the return item in the quantity field 570.

To ensure that the scanned item or manually entered number matches the return item, the clerk taps a “Detail” button 580 to display an item detail screen similar to the order detail screen illustrated in FIG. 48. The item detail screen provides the Economost™ number, UPC number, NDC number, local identifier, generic code, therapeutic code and orange book code. Additionally, the item detail screen lists the price of the item, the minimum quantity orderable, the average ordered quantity, the date of the last order and the number of orders for this item per year. When the clerk finishes reviewing the item detail screen, the clerk taps a “Done” button to return to the returns entry screen 564.

After reviewing the item details and entering the quantity of the return item, the clerk uses a return reason drop box 582 to display a list of reasons for the return as illustrated in FIG. 52. The clerk highlights one of the reasons from the return reason drop box 582 and then enters an invoice number at the “Inv#” line 584. If an invoice date is required by the distribution center 12 for the return, the clerk uses month, day and year drop boxes 586 to enter the invoice date.

After ensuring the information entered for the return is correct, the clerk taps an “Add” button 588 to add this item to the returns record. If the clerk wishes to remove this item from the returns record, the clerk taps a “Del” button 590. To continue with the returns process, the clerk scans more items, enters the required return information. The clerk may review previous return entries by using the arrows (not shown) on the second page of the returns entry screen 564 to see the description of those previous return entries. To complete the return record and save the entered information, the clerk taps a “Done” button 592 to return to the returns main screen 548. If the clerk wishes to return to the returns main screen 548 without saving the returns entries, the clerk taps a “Clear” button 594. To return to the returns header screen 554, the clerk taps a “Header” button 596.

After the returns have been entered and saved with the returns entry screen 564, the returns main screen 548 will display the returns record 598 as shown in FIG. 50. The returns main screen 548 displays the status (“Sts”) of “EDT” for edited returns record or “SND” for sent returns record. The returns main screen 548 also displays the number of lines (“Lns”), number of pieces (“Ps”), returns number (“Returns #”), and the date of the returns record (“DT”). If the clerk wishes to send the returns record to the retail computer system 336 or a stand-alone computer, the clerk highlights the returns record and taps a “Send” button 500. The returns record is sent to the retail computer system 336 or the stand-alone computer using the system described in conjunction with FIG. 28. Once the returns record is sent, the status field changes from “EDT” to “SND.” To delete the returns record, the clerk highlights the returns record and taps a “Del” button 602. The returns main page 548 also provides an “Info” button 604 that provides instructions on the returns procedure.

The returns procedures for the distribution system 10 of the present invention provide significant advantages. The retail device 300 improves the productivity and accuracy of the retail store 16. The returns procedures with the retail device 300 provide faster and easier training of personnel. The retail device 300 reduces the likelihood of erroneous returns because the retail device 300 provides returns records with the invoice number and date for the item. The retail device 300 also provides extensive item details on the screens allowing the clerk to easily verify the return item. The retail device 30 is also very portable allowing the clerk to roam freely about the retail store 16 to generate the returns. Moreover, once the retail store computer system 336 has the returns record, the returns record may be transferred to the distribution center computer system 68. The returns procedures improve the tracking of returned items and allows the retail store to be readily credited for those items.

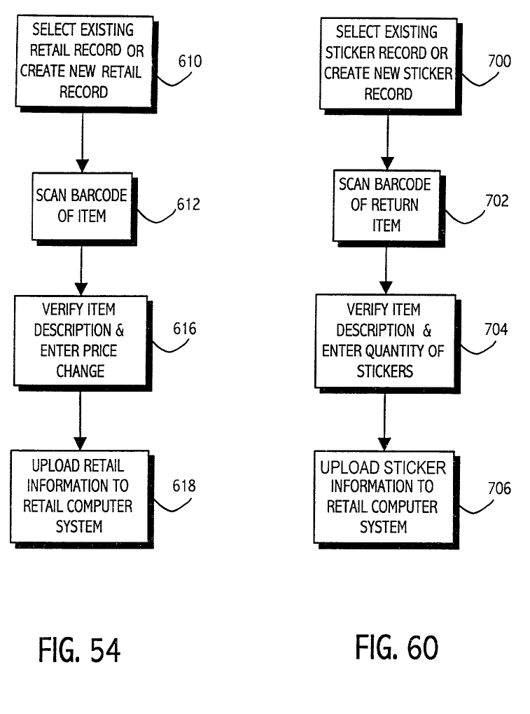

If the “Retail” option was selected on the home page screen 340, the clerk or anyone associated with the entity performs a retail price change process with the retail device 300. FIG. 54 generally illustrates one embodiment of the retail price change procedures performed with the retail device 300. First, the clerk of the retail store selects an existing retail record to modify or creates a new retail record on the retail device 300 at step 610. Next, the clerk scans the barcode of a return item at step 612. At step 614, the clerk verifies the item description displayed on the retail device 300 and enters a price change for the item. After all of the desired items have had their prices changed with the retail device 300, the retail price change information on the retail device 300 is uploaded to the retail computer system 336 at step 616. In an alternative embodiment, the retail price change information may be transferred from the retail device 300 directly to the distribution center computer system 68 or a standalone computer.

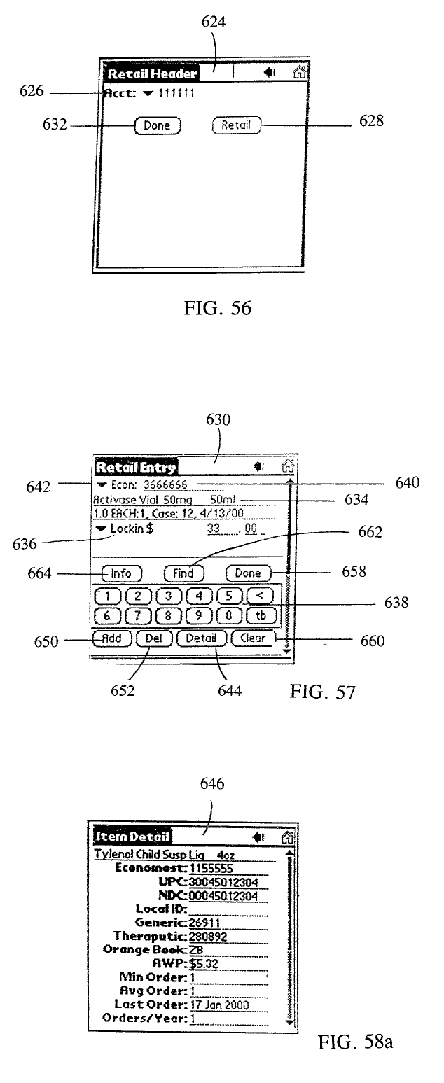

When the “Retail” option is selected on the home screen 340, the retail device 300 displays a returns main screen 618 as illustrated in FIG. 55. On the returns main screen 618, the clerk may change the prices of items with the retail device 300. To edit an existing retail record, the clerk highlights one of the listed retail records under a “New Retail Change” line 620 and taps an “Edit” button 622 to display a retail header screen as will be described in conjunction with creating a new retail record. To create the new retail record, the clerk highlights the “New Retail Change” line 620 and taps the “Edit” button 622 to display the retail header screen 624 as illustrated in FIG. 56. The clerk selects the proper account number from an “Acct” drop down list 626 which is populated with the appropriate numbers the retail store 16 as used with the Econolink™ software on the retail computer system 336. The clerk then taps a “Retail” button 628 to display a retail entry screen 630 as illustrated in FIG. 57. If the clerk wishes to go back to the retail main screen 618e, the clerk taps a “Done” button 632.

On the retail entry screen 630, the clerk enters the retail price change for items with the retail device 300. The clerk simply scans the barcodes from the shelf label for the Economost™ number or the barcode on the item for the UPC/NDC numbers. The retail device 300 automatically recognizes each kind of barcode and their associated item. If the scanned item is included in a retail store's database, the item information, including product identifier (either Economost™ number or UPC/NDC number), product description, unit of measure, case size, and last order date, will be displayed in an item information field 634. If the scanned item is not in the database, the retail device 300 displays a message “<NOT IN DEVICE DATABASE>” at the item information field 634. Even when this message appears, if the item is available, the retail price change will be accepted. After checking the item information, the clerk enters a dollar and cent amount for a new retail price for the item at a “Lockin $” 636. The retail entry screen 630 includes a keyboard 638 to assist the clerk with entering numbers for the retail price change process.

In addition to scanning barcodes, the clerk may manually enter the Economost™ number or UPC/NDC number of the item directly on an item line 640 using the keyboard 638 or graffiti area 306 of the retail device 300. Prior to entering the item number, the clerk sets whether the number is the Economost™ number or UPC/NDC number using a drop box 642.

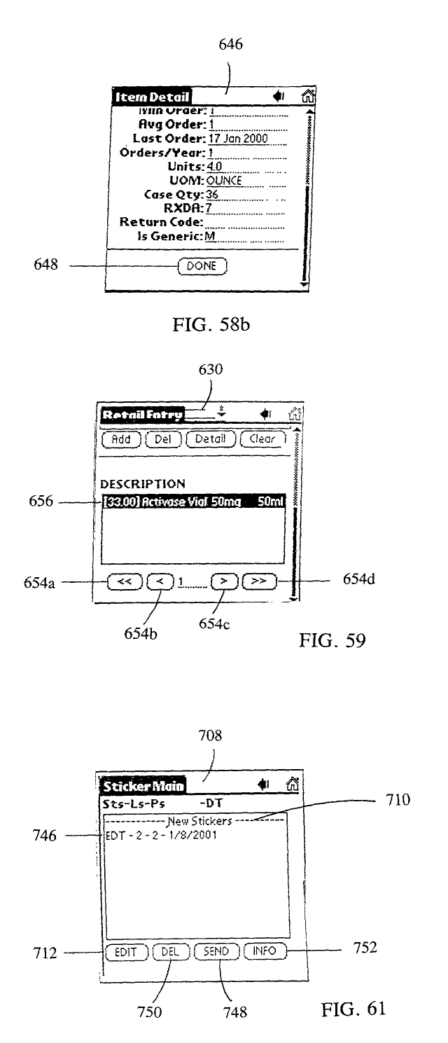

To ensure that the scanned item or manually entered number matches the item to retail price change, the clerk taps a “Detail” button 644 to display an item detail screen 646 illustrated in FIGS. 58a and 58b. The item detail screen 646 provides the Economost™ number, UPC number, NDC number, local identifier, generic code, therapeutic code, orange book code, and the unit price of the item. Additionally, the item detail screen 646 lists the minimum quantity orderable, the average ordered quantity, the date of the last order, the size of the item, the units of measurement, the number of units in a case, the RXDA number, the return code, and whether the item is generic. When the clerk finishes reviewing the item detail screen 646, the clerk taps a “Done” button 648 to return to the retail entry screen 630.

After reviewing the item details and entering the price change for the item displayed, the clerk taps an “Add” button 650 to add this price change entry to the retail record. If the clerk wishes to remove this entry from the retail record, the clerk taps a “Del” button 652. To continue with the retail price change process, the clerk scans more items, enters the new prices. The clerk may review previous retail entries by using the arrows 654a, 654b, 654c and 654d on the second page of the retail entry screen 646 to see the description and price of those previous retail entries 656 as illustrated in FIG. 59. The single arrows 654b, 654c move up or back one entry, and the double arrows 654a, 654d move to the top or end of the list.

To complete the retail record and save the entered information, the clerk taps a “Done” button 658 to return to the retail main screen 618. If the clerk wishes to return to the retail main screen 618 without saving the retail entries, the clerk taps a “Clear” button 660. To perform an item search as described above, the clerk taps a “Find” button 662. The retail entry page 646 also provides an “Info” button 664 that provides instructions on the retail procedures.

After the retail price changes have been entered on the retail entry screen 646, the retail main screen 618 will display the retail records 666 as shown in FIG. 55. The retail main screen 618 displays the status (“Sts”) of “EDT” for edited retail records or “SND” for sent retail records. The retail main screen 618 also displays the number of lines (“Lns”) and the date of the retail record (“DT”). If the clerk wishes to send the retail record to the retail computer system 336 or a stand-alone computer, the clerk highlights the retail record and taps a “Send” button 668. The retail record is sent to the retail computer system 336 or a stand-alone computer using the system described in conjunction with FIG. 28. Once the retail record is sent, the status field changes from “EDT” to “SND.” To delete the retail record, the clerk highlights the retail record and taps a “Del” button 670. The retail main page 618 also provides an “Info” button 672 that provides instructions on the retail price change procedures.

The retail price change procedures for the distribution system 10 of the present invention provide significant advantages. The retail device 300 improves the productivity and accuracy of the retail store 16. The retail price change procedures with the retail device 300 provide faster and easier training of personnel. The retail device 300 reduces the likelihood of erroneous orders because the retail device 300 provides retail records with the price change and date for the price change. The retail device 300 also provides extensive item details on the screens allowing the clerk to easily verify the retail price change item. The retail device 300 is also very portable allowing the clerk to roam freely about the retail store 16 to generate the retail price changes. Moreover, once the retail store computer system 336 has the retail record, the retail record may be transferred to the distribution center computer system 68. Once the distribution center computer system 68 has the retail record, the distribution center 12 changes the prices on the labels attached to the items that will be delivered to the retail store or the stickers supplied to the retail store. The retail price change procedures improve the tracking of price change requests and allows the retail store readily change the prices of item from the distribution center 12.

If the “Stickers” option was selected on the home page screen 340, the clerk or anyone associated with the entity performs a sticker request process with the retail device 300. FIG. 60 generally illustrates one embodiment of the sticker request procedures performed with the retail device 300. First, the clerk of the retail store selects an existing sticker record to modify or creates a new sticker record on the retail device 300 at step 700. Next, the clerk scans the barcode of an item needing a sticker at step 702. At step 704, the clerk verifies the item description displayed on the retail device 300 and a quantity of stickers for the item. After all of the stickers have been ordered for the desired items with the retail device 300, the sticker request information on the retail device 300 is uploaded to the retail computer system 336 with the EconoLink™ software at step 706. In an alternative embodiment, the sticker request information may be transferred from the retail device 300 directly to the distribution center computer system 68 or a stand-alone computer.

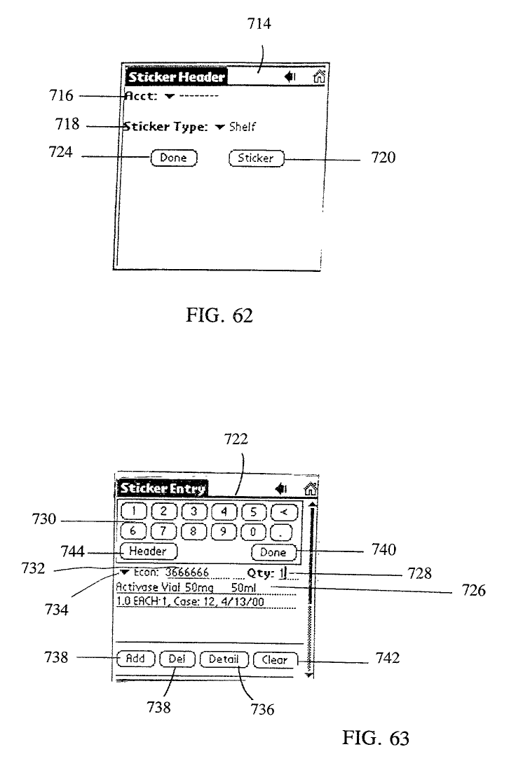

When the “Sticker” option is selected on the home screen 340, the retail device 300 displays a sticker main screen 708 as illustrated in FIG. 61. On the sticker main screen 708, the clerk begins the sticker request process. To edit an existing sticker record, the clerk highlights one of the listed sticker records under a “New Stickers” line 710 and taps an “Edit” button 712 to display a sticker header screen as will be described in conjunction with creating a new stickers record. To create the new stickers record, the clerk highlights the “New Stickers” line 710 and taps the “Edit” button 712 to display the sticker header screen 714 as illustrated in FIG. 62. The clerk selects the proper account number from an “Acct” drop down list 716 which is populated with the appropriate numbers the retail store 16 as used with the Econolink™ software on the retail computer system 336. The clerk then selects the desired sticker type, either shelf or price, from a sticker type drop box 718. After selecting the sticker type, the clerk taps a “Sticker” button 720 to display a sticker entry screen 722 as illustrated in FIG. 63. If the clerk wishes to go back to the sticker main screen 708, the clerk taps a “Done” button 724.

On the sticker entry screen 722, the clerk enters the items that need stickers with the retail device 300. The clerk simply scans the barcodes from the shelf labels for the Economost™ numbers or the barcodes on the actual items for the UPC/NDC numbers. The retail device 300 automatically recognizes each kind of barcode and their associated item. If the scanned item is included in a retail store's database, the item information, including product identifier (either Economost™ number or UPC/NDC number), product description, unit of measure, case size, and last order date, will be displayed in an item information field 726. If the scanned item is not in the database, the retail device 300 displays a message “<NOT IN DEVICE DATABASE>” in the item information field 726. Even when this message appears, if the item is available, the sticker record will be accepted. After checking the item information, the clerk enters a quantity of stickers for the item at a “Qty” field 728 that defaults to one. The sticker entry screen 722 includes a keyboard 730 to assist the clerk with entering numbers for the sticker request process.

In addition to scanning barcodes, the clerk may manually enter the Economost™ number or UPC/NDC number of the item directly on an item line 732 using the keyboard 730 or graffiti area 306 of the retail device 300. Prior to entering the item number, the clerk sets whether the number is the Economost™ number or UPC/NDC number using a drop box 734.

To ensure that the scanned item or manually entered number matches the sticker item, the clerk taps a “Detail” button 736 to display an item detail screen similar to the one illustrated in FIGS. 58a and 58b. The item detail screen provides the Economost™ number, UPC number, NDC number, local identifier, generic code, therapeutic code, orange book code, and the unit price of the item. Additionally, the item detail screen lists the minimum quantity orderable, the average ordered quantity, the date of the last order, the size of the item, the units of measurement, the number of units in a case, the RXDA number, the return code, and whether the item is generic. When the clerk finishes reviewing the item detail screen, the clerk taps a “Done” button to return to the sticker entry screen 722.

After reviewing the item details and entering the quantity of stickers requested, the clerk taps an “Add” button 738 to add a sticker entry for this item to the sticker record. If the clerk wishes to remove this item from the sticker record, the clerk taps a “Del” button 738. To continue with the sticker request process, the clerk scans more items, enters the type and quantity of stickers requested. The clerk may review previous sticker entries by using the arrows on the second page of the sticker entry screen 722.

To complete the sticker entries and save the entered information, the clerk taps a “Done” button 740 to return to the sticker main screen 708. If the clerk wishes to return to the sticker main screen 708 without saving the sticker entries, the clerk taps a “Clear” button 742. To return to the sticker header screen 714, the clerk taps a “Header” button 744.

After the sticker requests have been entered on the sticker entry screen 722, the sticker main screen 708 will display the sticker record 746 as shown in FIG. 61. The sticker main screen 708 displays the status (“Sts”) of “EDT” for edited sticker record or “SND” for sent sticker record. The sticker main screen 708 also displays the number of lines (“Lns”), number of pieces (“Ps”), and the date of the sticker record (“DT”). If the clerk wishes to send the sticker record to the retail computer system 336 or a stand-alone computer, the clerk highlights the sticker record 746 and taps a “Send” button 748. The sticker record is sent to the retail compute system 336 or a stand-alone computer using the system describing in conjunction with FIG. 28. Once the sticker record is sent, the status field changes from “EDT” to “SND.” To delete the sticker record, the clerk highlights the sticker record and taps a “Del” button 750. The retail main page 708 also provides a “Info” button 752 that provides instructions on the sticker request procedures.

The sticker request procedures for the distribution system 10 of the present invention provide significant advantages. The retail device 300 improves the productivity and accuracy of the retail store 16. The sticker request procedures with the retail device 300 provide faster and easier training of personnel. The retail device 300 reduces the likelihood of erroneous orders because the retail device 300 provides sticker records with the detailed descriptions of the item allowing the clerk to easily verify the item. The retail device 300 is also very portable allowing the clerk to roam freely about the retail store 16 to generate the sticker requests. Moreover, once the retail store computer system 336 has the sticker record, the sticker record may be transferred to the distribution center computer system 68. Once the distribution center computer system 68 has the sticker record, the distribution center 12 generates the requested stickers and sends them to the retail store. The sticker request procedures improve the tracking of sticker requests and allows the retail store readily request stickers from the distribution center 12.

While particular embodiments and applications of the present invention have been illustrated and described, it is to be understood that the invention is not limited to the precise construction and compositions disclosed herein and that various modifications, changes and variations will be apparent from the foregoing descriptions without departing from the spirit and scope of the invention as defined in the appended claims.

What is claimed is:

1. A distribution system for transferring a plurality of items from a distribution center to a customer, said distribution system comprising:
a delivery device capable of identifying said items and capable of maintaining a delivery record of said transfer of said items; and
a retail device capable of identifying said items and capable of maintaining a receipt record of said transfer of said items.

2. The distribution system of claim 1 wherein said delivery device upon identifying said item displaying an item description on a display screen.

3. The distribution system of claim 1 wherein said delivery device is a portable computer.

4. The distribution system of claim 1 wherein said delivery device includes a barcode scanner to identify said items.

5. The distribution system of claim 1 wherein said delivery device includes a data entry apparatus to enter transfer information into said delivery record.

6. The distribution system of claim 6 wherein said transfer information is an electronically captured signature.

7. The distribution system of claim 1 wherein said delivery device is further capable of storing a driver manifest record, said driver manifest record containing a listing of said items and a status of said items.

8. The distribution system of claim 4 wherein said driver manifest record further contains a listing of a second customer and a second plurality of items to be transferred to said second customer.

9. The distribution system of claim 1 wherein said retail device is further capable of creating an ordering record of a plurality of items by identifying a quantity of said item to order from said distribution center.

10. The distribution system of claim 1 wherein said retail device is further capable of creating an inventory record by identifying said items within a store.

11. The distribution system of claim 1 wherein said retail device is further capable of creating a price change record by identifying said item and saving a price change associated with said item.

12. The distribution system of claim 1 wherein said retail device is further capable of creating a returns record by identifying a return item to return to said distribution center.

13. The distribution system of claim 1 wherein said retail device is further capable of creating a sticker request record by identifying a sticker item in need of a sticker to accompany said sticker item.

14. The distribution system of claim 1 further including a distribution center computer capable of communicating with said delivery device.

15. The distribution system of claim 14 wherein said delivery device transfers said delivery record to said distribution center computer.

16. The distribution system of claim 14 wherein said retail device is capable of communicating with said distribution center computer.

17. A method for distributing a plurality of items to a customer comprising the steps of:
placing said items destined for said customer into a shipping unit;
placing a label on said shipping unit, said label having a unique identifier;
creating a shipment record identifying said shipping unit by said identifier and listing said items within said shipment unit;
sending said shipping record to said customer;
delivering said shipping unit to said customer;
receiving said shipping unit by said customer; and
identifying said shipping unit by said customer using said shipment record, said identifying by electronically reading said identifier on said label.

18. The method of claim 17 further including verifying contents of said shipping unit using said listing of said items within said container in said shipping record.

19. The method of claim 18 further including electronically recording any discrepancy between said contents of said shipping unit and said listing in said shipping record.

20. The method of claim 17 further including creating a delivery record of said delivery, said delivery record created by electronically reading said identifier.

21. The method of claim 18 further including creating a receipt record of said receipt of said shipping unit, said receipt record created by identifying said shipping unit and listing any differences between said items listed on said shipping record and said items within said container.

22. The method of claim 17 wherein said unique identifier is a barcode.

23. The method of claim 17 further including storing said shipment record on a portable computer.

24. The method of claim 17 further including electronically capturing a signature confirming delivery of said shipping unit to said customer.

25. The method of claim 17 further including electronically recording a time of delivery of said shipping unit to said customer.

26. A method of distributing a plurality of items from a warehouse to a remote site comprising the steps of:
creating an electronic shipment record of said items to be delivered to said remote site, said shipment record listing a shipping quantity of each of said items;
delivering said items at said remote site; and
creating an electronic delivery record of said items delivered at said remote site; said
delivery record listing a delivered quantity of each of said items and identifying any differences between said shipping quantity and said delivered quantity.
